(19) United States
(12) Patent Application Publication
(10) Pub. No.: US 2026/0339586 A1
(43) Pub. Date: Oct. 29, 2026

(54) METHOD OF CONTROLLING INFORMATION PROCESSING TERMINAL, DISPLAY SYSTEM, AND NON-TRANSITORY COMPUTER-READABLE STORAGE MEDIUM

(71) Applicant: SEIKO EPSON CORPORATION, Tokyo (JP)

(72) Inventors: Shota UTSUMI, SAPPORO-SHI (JP); Tang CHUN HO, Rolling Hills Estates, CA (US); Arevalo DANIELA PAZ, Highlands Ranch, CO (US); Perry LARRY, Los Angeles, CA (US); Takayuki YOKOYAMA, MATSUMOTO-SHI, NAGANO-KEN (JP)

(21) Appl. No.: 19/189,895

(22) Filed: Apr. 25, 2025

(51) Int. Cl. G06F 3/14

(52) U.S. Cl. CPC G06F 3/14

(57) ABSTRACT

A method of controlling an information processing terminal including acquiring event identification information generated based on information from a first information processing terminal, causing a display to display first output content which is generated by a plurality of first input contents acquired from the first information processing terminal and is associated with the event identification information during an event period associated with the event identification information, and causing the display to display second output content generated based on second input content acquired from a second information processing terminal that has acquired event invitation information associated with the event identification information by interrupting the display of the first output content when a first request of requesting the display to display at least one content is acquired from the second information processing terminal during the event period.

### BACKGROUND

### 1. Technical Field

The present disclosure relates to a method for controlling an information processing terminal, a display system, and a non-transitory computer-readable storage medium.

### 2. Related Art

In the projector system described in JP-A-2017-26715, a use schedule of a plurality of projectors is managed, and image information is transmitted to the projectors based on the use schedule (see JP-A-2017-26715).

Accordingly, for example, the projector is set to display predetermined image data such as guidance information at the date and time of an event such as an exhibition at an event site.

JP-A-2017-26715 is an example of the related art.

However, in such related art as described above, for example, in a participatory event such as a home party, a music festival, or a wedding ceremony, the sense of unity of event participants with respect to the event cannot be enhanced in some cases only by displaying predetermined image data alone with a projector.

### SUMMARY

An aspect is a method of controlling an information processing terminal including acquiring event identification information generated based on information from a first information processing terminal, causing a monitor to display first output content which is generated by a plurality of first input contents acquired from the first information processing terminal and is associated with the event identification information during an event period associated with the event identification information, and causing the monitor to display second output content generated based on second input content acquired from a second information processing terminal that has acquired event invitation information associated with the event identification information by interrupting the display of the first output content when a first request of requesting the monitor to display at least one content is acquired from the second information processing terminal during the event period.

An aspect is a display system including an information processing terminal, a first information processing terminal connected to the information processing terminal via a network, a second information processing terminal connected to the information processing terminal via the network, and a monitor connected to the information processing terminal via the network, wherein the information processing terminal acquires event identification information based on information from the first information processing terminal, makes the monitor display first output content which is generated by a plurality of first input contents acquired from the first information processing terminal and is associated with the event identification information in an event period associated with the event identification information, transmits event invitation information associated with the event identification information to the second information processing terminal, and makes the monitor display second output content generated based on second input content acquired from the second information processing terminal by interrupting the display of the first output content when a first request of requesting the monitor to display at least one content is acquired from the second information processing terminal during the event period.

An aspect is a non-transitory computer-readable storage medium storing a program, the program including acquiring event invitation information associated with event identification information generated based on information from a first information processing terminal, transmitting second input content during an event period associated with the event identification information, and transmitting, during the event period, a first request for requesting a monitor configured to display first output content, which is generated by a plurality of first input contents acquired from the first information processing terminal and is associated with the event identification information, to display second output content generated based on the second input content.

### BRIEF DESCRIPTION OF THE DRAWINGS

FIG. 1 is a diagram showing a configuration example of a display system according to an embodiment.

FIG. 2 is a diagram showing a configuration example of an information processing terminal according to the embodiment.

FIG. 3 is a diagram showing a configuration example of a monitor according to the embodiment.

FIG. 4 is a diagram showing a configuration example of first to fourth information processing terminales according to the embodiment.

FIG. 5 is a diagram showing an example of a flow of processing performed in a display system according to a first embodiment.

FIG. 6 is a diagram schematically showing content display in a monitor according to the first embodiment.

FIG. 7 is a diagram showing an example of a flow of processing performed in a display system according to a second embodiment.

FIG. 8 is a diagram showing an example of display of a first output content and a two-dimensional code according to the second embodiment.

FIG. 9 is a diagram showing an example of a flow of processing performed in a display system according to a third embodiment.

FIG. 10 is a diagram showing an example of a fifth output content according to the third embodiment.

FIG. 11 is a diagram showing an example of a flow of processing according to a second modified example.

FIG. 12 is a diagram showing an example of a flow of processing according to a third modified example.

### DESCRIPTION OF EMBODIMENTS

Some embodiments will hereinafter be described with reference to the drawings.

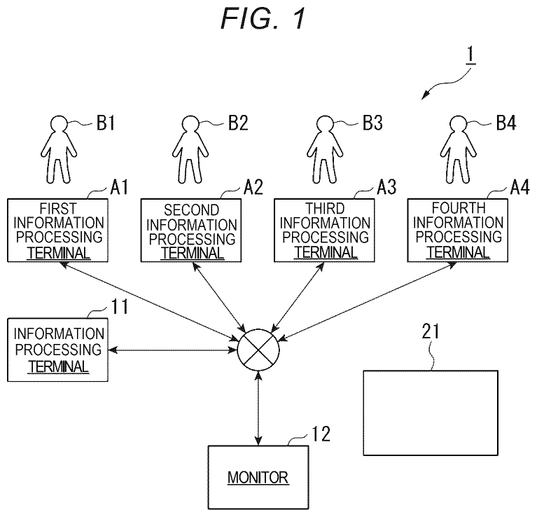

FIG. 1 is a diagram showing a configuration example of a display system 1 according to an embodiment.

The display system 1 includes an information processing terminal 11, a monitor 12, a screen 21, a first information processing terminal A1, a second information processing terminal A2, a third information processing terminal A3, and a fourth information processing terminal A4.

Each of the first information processing terminal A1 to the fourth information processing terminal A4 and the information processing terminal 11 can communicate with each other via a network C1.

Each of the first information processing terminal A1 to the fourth information processing terminal A4 and the monitor 12 can communicate with each other via the network C1.

Note that, for example, in the network C1, any two of the first information processing terminal A1 to the fourth information processing terminal A4 may be capable of communicating with each other.

Here, any network may be adopted as the network C1.

The network C1 is, for example, a wireless network, but may partially include a wired network.

Note that in the present embodiment, there is described when the first information processing terminal A1 to the fourth information processing terminal A4, the information processing terminal 11, and the monitor 12 are connected in common to the network C1, but the network C1 may include two or more types of networks as another example.

The first information processing terminal A1 is operated by a first user B1.

The second information processing terminal A2 is operated by the second user B2.

The third information processing terminal A3 is operated by a third user B3.

The fourth information processing terminal A4 is operated by a fourth user B4.

In the present embodiment, the first information processing terminal A1 is a smartphone and is owned by the first user B1.

In the present embodiment, the second information processing terminal A2 is a smartphone and is owned by the second user B2.

In the present embodiment, the third information processing terminal A3 is a smartphone and is owned by the third user B3.

In the present embodiment, the fourth information processing terminal A4 is a smartphone and is owned by the fourth user B4.

Note that any apparatus may be adopted as each of the first information processing terminal A1 to the fourth information processing terminal A4, and a tablet or a notebook computer, for example, may be adopted.

In the present embodiment, the information processing terminal 11 is a server apparatus, but may be another apparatus.

Further, various devices may be used as the monitor 12.

In the present embodiment, the monitor 12 is a projector, and projects information of a display object to the screen 21 to thereby display the information on a surface of the screen 21.

As another example, the monitor 12 may be a monitor that displays the information of the display object on a screen. In this case, the screen 21 is not required to be provided.

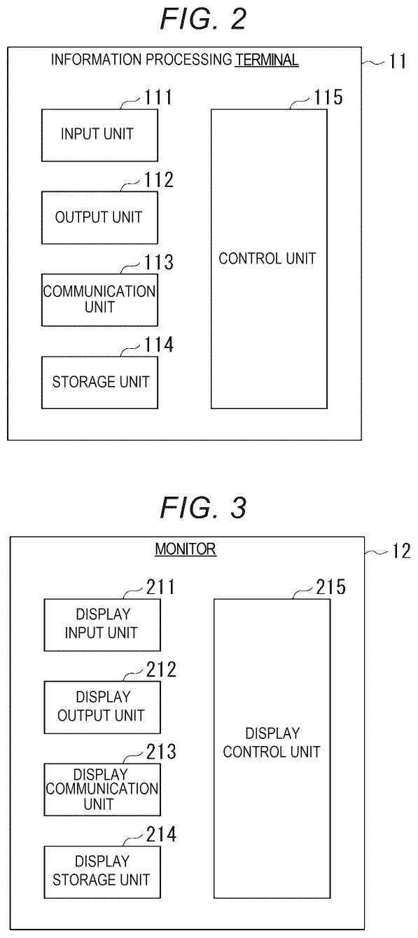

FIG. 2 is a diagram showing a configuration example of the information processing terminal 11 according to the embodiment.

In the present embodiment, the information processing terminal 11 is configured using a computer.

The information processing terminal 11 includes an input unit 111, an output unit 112, a communication unit 113, a storage unit 114, and a control unit 115.

The input unit 111 has a function of inputting information.

The output unit 112 has a function of outputting information.

The communication unit 113 has a function of performing communication.

Note that the communication unit 113 is illustrated separately from the input unit 111 and the output unit 112 in the present embodiment, but, for example, a function of a reception unit among the functions of the communication unit 113 may be provided to the function of the input unit 111, and a function of a transmission unit among the functions of the communication unit 113 may be provided to the function of the output unit 112.

The storage unit 114 stores information.

Note that the information processing terminal 11 may be configured to use an external database (not illustrated) instead of the storage unit 114 or together with the storage unit 114 to perform at least one of storing information in the database and acquiring information from the database.

The control unit 115 performs various types of processing or control in the information processing terminal 11.

In the present embodiment, the control unit 115 includes a predetermined processor such as a central processing unit (CPU), and performs the various types of processing or control by the processor executing a control program.

The control program may be stored in, for example, the storage unit 114.

FIG. 3 is a diagram showing a configuration example of the monitor 12 according to the embodiment.

The monitor 12 is configured using, for example, a computer.

The monitor 12 includes a display input unit 211, a display output unit 212, a display communication unit 213, a display storage unit 214, and a display control unit 215.

The display input unit 211 has a function of inputting information.

The display output unit 212 has a function of outputting information.

The display communication unit 213 has a function of performing communication.

Note that the display communication unit 213 is illustrated separately from the display input unit 211 and the display output unit 212 in the present embodiment, but for example, a function 4-a reception unit among the functions of the display communication unit 213 may be provided to the function of the display input unit 211, and a function of a transmission unit among the functions of the display communication unit 213 may be provided to the function of the display output unit 212.

The display storage unit 214 stores information.

The display control unit 215 performs various types of processing or control in the monitor 12.

In the present embodiment, the display control unit 215 includes a predetermined processor such as a CPU, and performs the various types of processing or control by the processor executing a control program.

The control program may be stored in, for example, the display storage unit 214.

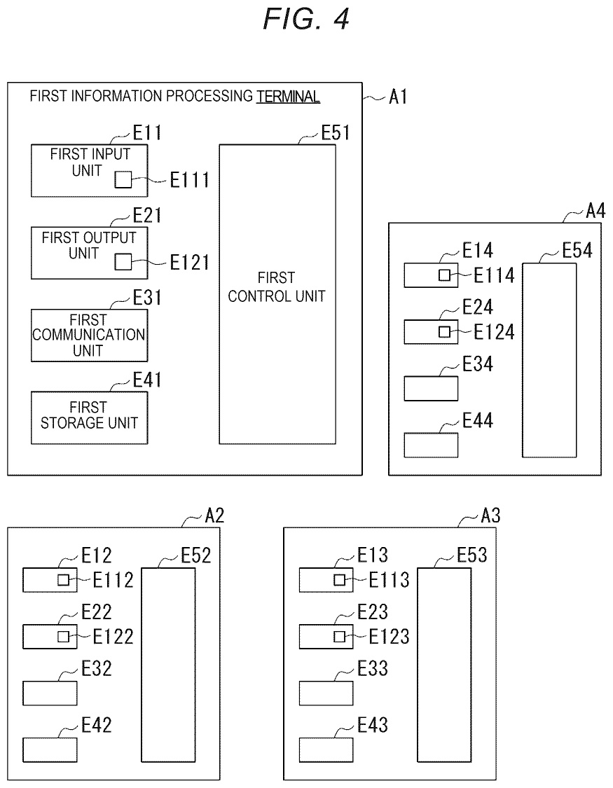

FIG. 4 is a diagram showing a configuration example of the first information processing terminal A1 to the fourth information processing terminal A4 according to the embodiment.

Here, in the present embodiment, since the first information processing terminal A1 to the fourth information processing terminal A4 include substantially the same elements, the configuration examples will be described in a lump for the sake of convenience of explanation.

However, the first information processing terminal A1 to the fourth information processing terminal A4 may be different from each other in terms of, for example, whether a predetermined application is installed, or operations performed by the respective information processing terminales.

The first information processing terminal A1 will be described.

In the present embodiment, the first information processing terminal A1 is configured using a computer.

The first information processing terminal A1 includes a first input unit Ell, a first output unit E21, a first communication unit E31, a first storage unit E41, and a first control unit E51.

The first input unit E11 includes a first operation unit E111.

The first output unit E21 includes a first display unit E121.

The first input unit E11 has a function of inputting information.

For example, the first operation unit E111 receives and inputs the content of the operation performed by the first user B1.

The first output unit E21 has a function of outputting information.

For example, the first display unit E121 displays information of the display object on a screen.

Here, the first operation unit E111 and the first display unit E121 may be commonalized using, for example, a touch panel.

The first communication unit E31 has a function of performing communication.

Note that in the present embodiment, the first communication unit E31 is illustrated separately from the first input unit E11 and the first output unit E21, but for example, a function of a reception unit among the functions of the first communication unit E31 may be provided to the function of the first input unit Ell, and a function of a transmission unit among the functions of the first communication unit E31 may be provided to the function of the first output unit E21.

The first storage unit E41 stores information.

The first control unit E51 performs various types of processing or control in the first information processing terminal A1.

In the present embodiment, the first control unit E51 includes a predetermined processor such as a CPU, and performs the various types of processing or control by the processor executing a control program.

The control program may be stored in, for example, the first storage unit E41.

The second information processing terminal A2 will be described.

In the present embodiment, the second information processing terminal A2 is configured using a computer.

The second information processing terminal A2 includes a second input unit E12, a second output unit E22, a second communication unit E32, a second storage unit E42, and a second control unit E52.

The second input unit E12 includes a second operation unit E112.

The second output unit E22 includes a second display unit E122.

Here, since a configuration of the second information processing terminal A2 is substantially the same as a configuration of the first information processing terminal A1, a detailed description thereof will be omitted.

The third information processing terminal A3 will be described.

In the present embodiment, the third information processing terminal A3 is configured using a computer.

The third information processing terminal A3 includes a third input unit E13, a third output unit E23, a third communication unit E33, a third storage unit E43, and a third control unit E53.

The third input unit E13 includes a third operation unit E113.

The third output unit E23 includes a third display unit E123.

Here, since a configuration of the third information processing terminal A3 is substantially the same as a configuration of the first information processing terminal A1, a detailed description thereof will be omitted.

The fourth information processing terminal A4 will be described.

In the present embodiment, the fourth information processing terminal A4 is configured using a computer.

The fourth information processing terminal A4 includes a fourth input unit E14, a fourth output unit E24, a fourth communication unit E34, a fourth storage unit E44, and a fourth control unit E54.

The fourth input unit E14 includes a fourth operation unit E114.

The fourth output unit E24 includes a fourth display unit E124.

Here, since a configuration of the fourth information processing terminal A4 is substantially the same as a configuration of the first information processing terminal A1, a detailed description thereof will be omitted.

A first embodiment will be described.

In the present embodiment, processing performed by the information processing terminal 11 shown in FIG. 1, the monitor 12, the first information processing terminal A1 operated by the first user B1, and the second information processing terminal A2 operated by the second user B2 will be described.

In the processing according to the present embodiment, the third information processing terminal A3 and the fourth information processing terminal A4 are not required to be provided.

In the present embodiment, the information processing terminal 11 stores a predetermined application program for executing the processing according to the present embodiment in the storage unit 114, and executes the application program with the control unit 115. In the present embodiment, the application program is a program for a server.

In the present embodiment, the monitor 12 stores a predetermined application program for executing the processing according to the present embodiment in the display storage unit 214, and executes the application program with the display control unit 215. In the present embodiment, the application program is a program for a projector.

Further, in the present embodiment, the first information processing terminal A1 stores a predetermined application program for executing the processing according to the present embodiment in the first storage unit E41, and executes the application program with the first control unit E51. In the present embodiment, the application program is a program for a smartphone.

Further, in the present embodiment, the second information processing terminal A2 stores a predetermined application program for executing the processing according to the present embodiment in the second storage unit E42, and executes the application program with the second control unit E52. In the present embodiment, the application program is a program for a smartphone.

In the present embodiment, for the sake of convenience of explanation, content supplied from the first information processing terminal A1 is referred to as first input content, and content displayed on the monitor 12 based on the first input content is referred to as first output content.

Here, for example, the first input content may be stored in the first storage unit E41 of the first information processing terminal A1 and may be supplied from the first storage unit E41.

Further, the first output content may be, for example, content which is the first input content or content obtained by processing the first input content, and is displayed in a predetermined period.

Further, in the present embodiment, for the sake of convenience of explanation, content supplied from the second information processing terminal A2 is referred to as second input content, and content displayed on the monitor 12 based on the second input content is referred to as second output content.

Here, for example, the second input content may be stored in the second storage unit E42 of the second information processing terminal A2 and may be supplied from the second storage unit E42.

Further, the second output content may be, for example, content which is the second input content or content obtained by processing the second input content, and is displayed in a predetermined period.

In the present embodiment, an image is used as the content. The image may be, for example, a still image or a moving image. The moving image may be referred to as, for example, a video picture.

Note that a plurality of pieces of content may be referred to as a content group.

Further, a plurality of images may be referred to as an image group.

In the present embodiment, the first user Bl is an organizer who holds a home party, which is an example of the event. Note that holding by the organizer may be referred to as, for example, hosting.

The monitor 12 is a projector owned by the first user B1. The screen 21 is installed at a place where the screen 21 can be viewed from the site of the home party.

The second user B2 is an invitee to the home party and is a participant participating in the home party.

Note that the event in the present embodiment may be applied to various events.

Further, the event in the present embodiment may be applied to an event from the start to the end of an event generally called, for example, a home party, a music festival, or a wedding ceremony, or may be applied to an event in a part of the entire period of a home party, a music festival, a wedding ceremony, or the like.

That is, the event in the partial period may be referred to as an event, and as another example, the event in the partial period may be referred to as a sub-event in the entire event.

As a specific example, the entire event may be a home party, a music festival, a wedding ceremony, or the like, and a sub-event in the event may be an event for a predetermined period such as a side show or a photo shoot.

The display system 1 executes five types of processing of generation of an event, storage of the first input content, start of the event, display of the second output content based on the second input content, and end of the event.

Note that at the start of the event, display of the first output content based on the first input content is started.

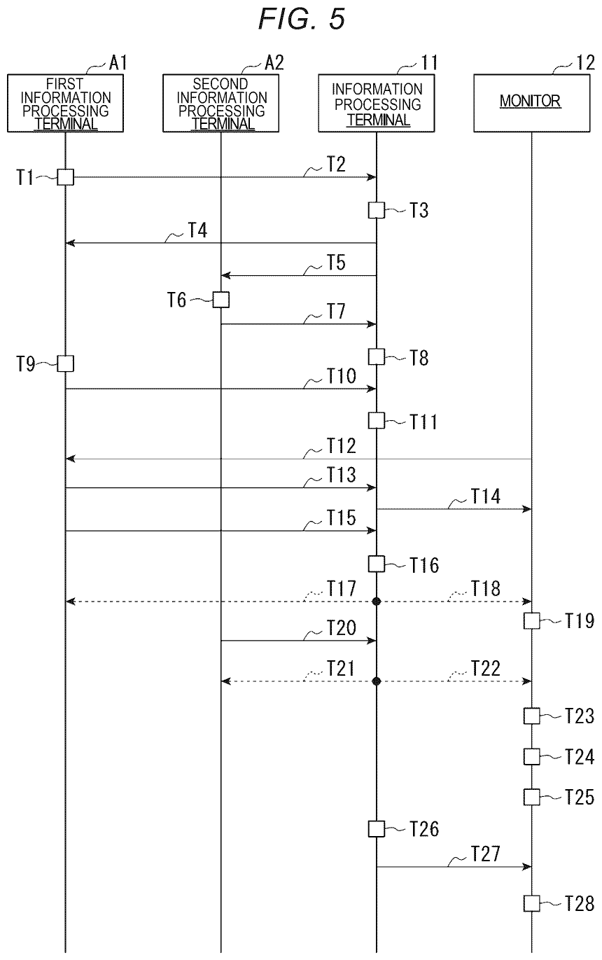

FIG. 5 is a diagram showing an example of a flow of processing performed in the display system 1 according to the first embodiment.

FIG. 5 schematically illustrates the information processing terminal 11, the monitor 12, the first information processing terminal A1, and the second information processing terminal A2.

A procedure of generating an event will be described.

In processing T1, the first information processing terminal A1 acquires an event generation request by an operation of the first user B1.

In processing T2, the first information processing terminal A1 transmits information related to the event date and time acquired by the operation of the first user B1, information related to the invitee, the event generation request, and an organizer user ID to the information processing terminal 11.

Thus, the first information processing terminal A1 generates the event.

Here, the invitee represents a person who is invited to the event.

Further, the information related to the invitee to the event may include, for example, information for identifying the event to which the invitee is invited and information for identifying the invitee. Such information related to the invitee is, for example, information for identifying an invitation to the event, and may be referred to as event invitation information or the like.

Further, in the present embodiment, the organizer user ID is identification information (ID: Identification) of the first user B1 who hosts the event.

Further, the information related to the event date and time includes, for example, the date and time when the event starts and the date and time when the event ends. In this case, the period of the event is represented by the information related to the event date and time.

As the information related to the date and time when the event starts, the date and time such as “2024/10/30 10:00” may be used.

Similarly, the date and time such as “2024/10/30 17:00” may be used as the information on the date and time when the event ends.

Note that, in the present embodiment, the period of the event represents a period of the entire event from the start to the end of one event such as a home party, but as another example, the period of the event may represent the period of a side show as a part of such a single event, that is, the period of a specific sub-event.

Here, when the period of the event represents the period of a specific sub-event in the single event, for example, the information related to the event may be attached to the information related to the sub-event, or is not required to be attached thereto. That is, the sub-event may be figured out as a sub-event in a certain event, or the sub-event itself may be figured out as an independent event.

In processing T3, when the information processing terminal 11 receives the information related to the event date and time, the information related to the invitee, the event generation request, and the organizer user ID, the information processing terminal 11 generates an event ID. Then, the information processing terminal 11 stores the event ID in the storage unit 114 in association with the information related to the event date and time, the information related to the invitee, and the organizer user ID.

Here, the event ID is an example of event identification information that is information for identifying the event. Note that as the event identification information, for example, the name of the event may be used.

Note that the event identification information may be generated by the first information processing terminal A1, for example, or the first information processing terminal A1 may notify the information processing terminal 11 of the event identification information.

In processing T4, the information processing terminal 11 transmits the event ID to the first information processing terminal A1.

In processing T5, the information processing terminal 11 extracts the invitee user ID corresponding to the invitee from the storage unit 114 based on the information related to the invitee, and transmits an event invitation to the invitee.

Here, in the present embodiment, the invitees include the second user B2. Then, the information processing terminal 11 transmits the event invitation to the second information processing terminal A2 of the second user B2.

The event invitation may be transmitted using, for example, an e-mail.

Further, in the present embodiment, the invitee user ID, which is the ID of the user to be the invitee, may be provided to, for example, the information related to the invitee or information capable of identifying the invitee user ID based on the information related to the invitee may be stored in the storage unit 114 of the information processing terminal 11.

Further, the event invitation may be directly transmitted, for example, from the first information processing terminal A1 of the organizer to the second information processing terminal A2 of the invitee.

In processing T6, the second information processing terminal A2 notifies the second user B2 of the fact that the event invitation has been received.

In processing T7, the second information processing terminal A2 transmits event attendance information or event absence information acquired by the operation of the second user B2 and the invitee user ID to the information processing terminal 11.

In processing T8, the information processing terminal 11 stores the event attendance information or the event absence information and the invitee user ID in the storage unit 114 in association with the event ID.

Here, in the present embodiment, the invitee user ID is the ID of the second user B2.

The event attendance information represents that the second user B2 attends the event. On the other hand, the event absence information represents that the second user B2 is absent from the event.

A procedure for storing the first input content will be described.

In processing T9, the first information processing terminal A1 selects an event ID. Then, the first information processing terminal A1 displays a list of moving images or still images stored in the first storage unit E41.

Here, the event ID may be selected by, for example, an operation of the first user B1, or may be automatically selected by the first information processing terminal A1.

In processing T10, the first information processing terminal A1 transmits the plurality of images selected by the operation of the first user B1 and selection order information to the information processing terminal 11.

Here, the plurality of images may include, for example, a plurality of moving images, a plurality of still images, or both one or more moving images and one or more still images.

Further, the selection order information indicates, for example, the order in which the plurality of images is selected.

In processing T11, the information processing terminal 11 stores the plurality of images and the selection order information in the storage unit 114 in association with the event ID.

A procedure for starting an event will be described.

The first information processing terminal A1 is connected to the monitor 12 via wireless communication with the network C1.

In processing T12, the monitor 12 transmits a monitor ID to the first information processing terminal A1.

Here, the monitor ID is identification information (ID) of the monitor 12.

In processing T13, the first information processing terminal A1 transmits the monitor ID to the information processing terminal 11.

In processing T14, the information processing terminal 11 establishes the wireless communication with the monitor 12 based on the monitor ID.

In processing T15, the first information processing terminal A1 selects the event ID and the monitor ID, and transmits the event ID, the event start request, and the monitor ID to the information processing terminal 11.

In processing T16, upon reception of the event start request, the information processing terminal 11 acquires information related to the corresponding event date and time from the storage unit 114, and determines whether the event date and time acquired are reached.

As a result, when the information processing terminal 11 determines that the event date and time are not reached, the information processing terminal 11 transmits the fact that the event is not started to the first information processing terminal A1 in processing T17, and ends the processing of the procedure of starting the event.

On the ther hand, when the information processing terminal 11 determines that the event date and time are reached, the information processing terminal 11 acquires the plurality of images and the selection order information from the storage unit 114 and transmits the plurality of images and the selection order information to the monitor 12 in processing T18.

Here, either one of the processing T17 and the processing T18 is performed. In the example of FIG. 5, processing after the processing T18 is also illustrated for the sake of convenience of explanation, but when the processing T17 is performed, subsequent processing is not performed.

In processing T19, the monitor 12 rearranges the plurality of images received based on the selection order information, and adds delimiter information to the boundary between the images to thereby generate the first output content. Then, the monitor 12 displays the first output content.

The delimiter information is, for example, information representing a breakpoint between two images which temporally continue, and may be configured using a time indicating a reproduction timing, or a number indicating a reproduction order as a specific example.

In the present embodiment, the monitor 12 generates the first output content from the plurality of first input contents. In the present embodiment, the plurality of first input contents is a plurality of images.

Here, the first output content is, for example, content such as a slide show including the delimiter information at a boundary between a plurality of images.

The slide show may be, for example, information for displaying a plurality of still images or moving images supplied from the first information processing terminal A1 in a predetermined order for a predetermined period.

As the predetermined order, for example, an order in which the first user B1 selects the still images or the moving images in the first information processing terminal A1 may be used, or another order may be used.

The predetermined period is not particularly limited, and may be a period set in advance, such as 30 [seconds] or 1 [minute]. For example, the period may be set in the monitor 12 in advance or may be set in the first information processing terminal A1.

A procedure of displaying the second output contents based on the second input contents will be described.

In processing T20, the second information processing terminal A2 selects the event ID. Then, the second information processing terminal A2 displays a list of moving images or still images stored in the second storage unit E42.

Here, the event ID may be selected by, for example, an operation of the second user B2 or may be automatically selected by the second information processing terminal A2.

In the processing T20, the second information processing terminal A2 transmits the image selected by the operation of the second user B2 and the content display request to the information processing terminal 11.

Here, the image may be, for example, a moving image or a still image.

When the information processing terminal 11 receives the content display request, the information processing terminal 11 acquires the information related to the event date and time from the storage unit 114, and determines whether the event date and time are reached.

As a result, when the information processing terminal 11 determines that the event date and time are not reached, the information processing terminal 11 transmits the fact that it is not in the event period to the second information processing terminal A2 in processing T21, and ends the processing of the procedure of displaying the second output content based on the second input content.

On the other hand, when the information processing terminal 11 determines that the event date and time are reached, the information processing terminal 11 transmits the image, which is received from the second information processing terminal A2, to the monitor 12 in processing T22.

Here, either one of the processing T21 and the processing T22 is performed. Note that in the example of FIG. 5, processing the processing T22 is also illustrated for the sake of convenience of explanation, but when the processing T21 is performed, subsequent processing is not performed.

In processing T23, the monitor 12 generates the second output content based on the image received and stores the second output content in the display storage unit 214.

In the present embodiment, the monitor 12 generates the second output content from the second input content.

Here, for example, when the image received is a still image, the monitor 12 may generate the second output content as content of displaying the still image for a predetermined time.

Further, for example, when the image received is a moving image, the monitor 12 may generate the second output content using the moving image as it is, or may generate the second output content using a moving image obtained by shortening the moving image.

As a specific example, the monitor 12 determines whether the reproduction period of the moving image received exceeds a predetermined period, and executes processing of shortening the moving image when the monitor 12 determines that the reproduction period exceeds the predetermined period.

As the processing of shortening the moving image, for example, processing of thinning out frames of the moving image or processing of increasing the reproduction speed of the moving image may be used, and thus it is possible to shorten the reproduction period of the moving image.

Note that when the monitor 12 determines that the reproduction period of the moving image received does not exceed the predetermined period, the monitor 12 may use the moving image as it is.

In processing T24, the monitor 12 acquires reproduction time information of the first output content, and stores the delimiter information, which is posterior to the reproduction time information and is the closest to the reproduction time, in the display storage unit 214.

Here, the delimiter information corresponds to the temporally subsequent delimiter information in the first output content in reproduction, that is, corresponds to the delimiter information that occurs the earliest.

In processing T25, the monitor 12 displays the first output content up to the delimiter information thus stored.

Subsequently, the monitor 12 displays the second output content.

Then, after the display of the second output content is completed, the monitor 12 displays the first output content posterior to the delimiter information based on the delimiter information acquired from the display storage unit 214.

That is, in the monitor 12, the reproduction of the first output content is temporarily stopped at the location of the delimiter information provided to the first output content in reproduction, the second output content is reproduced instead by interruption, and then the reproduction of the first output content is resumed from the location of the delimiter information.

A procedure for ending the event will be described.

In the present embodiment, after the information processing terminal 11 receives the event start request and then determines that the event date and time are reached, the information processing terminal 11 acquires the information related to the event date and time from the storage unit 114 and determines whether the event date and time pass every time a predetermined period elapses.

As a result, when the information processing terminal 11 determines that the event date and time do not pass, the information processing terminal 11 ends the processing of the procedure for ending the event in processing T26.

On the other hand, when the information processing terminal 11 determines that the date and time pass, the information processing terminal 11 transmits event end information to the monitor 12 in processing T27.

In processing T28, upon reception of the event end information, the monitor 12 stops displaying the first output content or the second output content.

In the present embodiment, a period from the start to the end of the event date and time is the event period.

Here, in the present embodiment, the display storage unit 214 of the monitor 12 stores the first output content and the second output content.

The first output content is content including a plurality of images uploaded to the information processing terminal 11 by the first information processing terminal A1.

The second output content is content including one image uploaded to the information processing terminal 11 by the second information processing terminal A2.

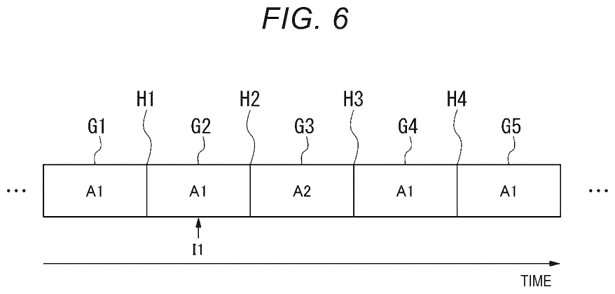

FIG. 6 is a diagram schematically showing content display in the monitor 12 according to the first embodiment.

The horizontal axis shown in FIG. 6 represents time.

FIG. 6 schematically illustrates that a first image G1, a second image G2, a third image G3, a fourth image G4, and a fifth image G5 are sequentially displayed by the monitor 12.

In the present example, the first image Gl and the second image G2 are images of the first output content.

In the present example, the content display request from the second information processing terminal A2 is generated during the reproduction of the second image G2. Thus, the third image G3 is an image of the second output content.

Subsequently, the fourth image G4 and the fifth image G5 are images of the first output content again.

Here, the first image G1, the second image G2, the fourth image G4, and the fifth image G5 may be, for example, the same image provided to the first output content, or one more the first image G1, the second image G2, the fourth image G4, and the fifth image G5 are different images provided to the first output content.

Note that when the first image G1, the second image G2, the fourth image G4, and the fifth image G5 are the same image, the same image is repeatedly reproduced by the reproduction of the first output content when there is no interruption of the content.

A first break position H1 based on the delimiter information is located between the first image G1 and the second image G2.

A second break position H2 based on the delimiter information is located between the second image G2 and the third image G3.

Between the third image G3 and the fourth image G4, there is a third break position H3 which is a break position due to the completion of the display of the image of the second output content which is the third image G3.

A fourth break position H4 based on the delimiter information is located between the fourth image G4 and the fifth image G5.

As described above, in the display system 1 according to the present embodiment, the sense of unity of the event participants with respect to the event can be enhanced.

As a configuration example, in the control method of the information processing terminal 11, the following processing is performed.

In the control method, the event identification information generated based on the information from the first information processing terminal A1 is acquired.

In the control method, the monitor 12 is set to display the first output content during the event period associated with the event identification information. Here, the first output content is generated by the plurality of first input contents acquired from the first information processing terminal A1, and is associated with the event identification information.

In the control method, when a first request for requesting the monitor 12 to display at least one content is acquired from the second information processing terminal A2 that has acquired the event invitation information associated with the event identification information during the event period, the monitor 12 is set to display the second output content by interrupting the display of the first output content. Here, the second output content is generated based on the second input content acquired from the second information processing terminal A2.

Note that in the present embodiment, the content display request is an example of the first request.

Therefore, in the method of controlling the information processing terminal 11, the second information processing terminal A2 that has acquired the event invitation information can transmit the second input content and the first request to the information processing terminal 11 to make the monitor 12 display the second output content as interrupt.

Accordingly, in the method of controlling the information processing terminal 11, since the event participant can add the content to be displayed by the monitor 12, it is possible to enhance the sense of unity of the event participants with respect to the event.

Here, in the present embodiment, when the content is displayed by the single monitor 12 provided to the display system 1 is described, but as another example, a plurality of monitors may be provided, and the content may be displayed by the plurality of monitors. For example, the first output content may be displayed in common by the plurality of monitors, or the first output content different by the monitor may be displayed by the plurality of monitors. The first output content to be displayed by each of the monitors may be designated by, for example, the first information processing terminal A1.

In such a case, for example, the interrupted display of the second output content may be performed in common by all the monitors, or may be performed by one or more of the monitors. When the interrupted display of the second output content is performed by some of the monitors, which monitor performs the interrupted display may be designated by, for example, the second information processing terminal A2, may be designated by the information processing terminal 11, or may be determined by each of the monitors.

When the monitor is designated by the second information processing terminal A2, the designation may be performed, for example, in accordance with an operation by the second user B2, or may be performed according to a rule set in advance.

When a monitor is designated by the information processing terminal 11, the designation may be performed, for example, according to a rule set in advance.

When it is determined, by each monitor, whether to perform the interrupted display, this determination may be performed, for example, according to a rule set in advance.

Note that the plurality of monitors may be identified using, for example, the identification information (monitor ID) of each of the monitors.

Here, in the present embodiment, the information processing terminal 11 can be connected to a larger number of devices than the upper limit number of devices connectable to the monitor 12 via wireless communication. In the present embodiment, the devices are the first information processing terminal A1 and the second information processing terminal A2, and the information processing terminal 11 can be connected to a larger number of such devices to connect these devices to the monitor 12.

Incidentally, in general, an upper limit number of communicable devices is set to a communication unit provided to a monitor such as a projector, and the number is not so large. Therefore, in such a general technique, in a participatory event such as a home party, a music festival, or a wedding ceremony, the number of communicable devices is limited by a monitor main body, and the sense of unity of event participants with respect to the event cannot be enhanced in some cases.

As a configuration example, in the method of controlling the information processing terminal 11, the first request is not accepted outside the event period.

Therefore, in the method of controlling the information processing terminal 11, it is possible to prevent the content requested by the event participant outside the event period from being displayed on the monitor 12.

For example, it is possible to ensure the security of the monitor 12 by preventing the monitor 12 from displaying the content requested by the event participant outside the event period of one entire event instead of the sub-event.

In addition, for example, by preventing the monitor 12 from displaying the content requested by the event participant outside the event period related to the sub-event in one entire event, the event organizer can select or determine, in the entire event, a period in which the event organizer wants to increase the sense of unity of the event participants and a period in which the event organizer wants to advance the event as intended rather than increasing the sense of unity of the event participants.

Here, the present embodiment includes both when the outside of the event period represents an outside of the event period of one event such as a home party, a music festival, or a wedding ceremony, and when the outside of the event period represents an outside of a sub-event period related to a sub-event such as a side show as a part of one event such as a home party, a music festival, or a wedding ceremony.

Note that any configuration may be used as the configuration that does not accept the content display request.

As an example, there may be used a configuration in which when the second information processing terminal A2 transmits the first request as the display request to the information processing terminal 11, the information processing terminal 11 performs processing of rejecting the first request. In this case, the information processing terminal 11 rejects the first request after receiving the first request.

As another example, there may be used a configuration in which when the second information processing terminal A2 transmits the first request as the display request to the information processing terminal 11, the information processing terminal 11 performs the processing of rejecting the reception of the first request.

As another example, there may be used a configuration in which the second information processing terminal A2 performs processing of prohibiting the operation of the first request by the second user B2. As the processing of prohibiting the operation of the first request, there may be used, for example, processing of preventing the second user B2 from participating in the corresponding event or processing of graying out an operation part such as a button on a screen for instructing the first request by the second user B2 to stop accepting the operation.

As a configuration example, the following configuration is adopted in the display system 1.

The display system 1 includes the information processing terminal 11, the first information processing terminal A1, the second information processing terminal A2, and the monitor 12.

The first information processing terminal A1 is connected to the information processing terminal 11 via the network C1.

The second information processing terminal A2 is connected to the information processing terminal 11 via the network C1.

The monitor 12 is connected to the information processing terminal 11 via the network C1.

The information processing terminal 11 acquires the event identification information based on the information from the first information processing terminal A1, and makes the monitor 12 display the first output content, which is generated by the plurality of first input contents acquired from the first information processing terminal A1 and is associated with the event identification information, during the event period associated with the event identification information.

Further, when the information processing terminal 11 transmits the event invitation information associated with the event identification information to the second information processing terminal A2 and acquires the first request for requesting the monitor 12 to display at least one content from the second information processing terminal A2 during the event period, the information processing terminal 11 makes the monitor 12 display the second output content generated based on the second input content acquired from the second information processing terminal A2 by interrupting the display of the first output content.

Therefore, in the method of controlling the information processing terminal 11, the second information processing terminal A2 that has acquired the event invitation information can transmit the second input content and the first request to the information processing terminal 11 to make the monitor 12 display the second output content as interrupt.

Accordingly, in the method of controlling the information processing terminal 11, since the event participant can add the content to be displayed by the monitor 12, it is possible to enhance the sense of unity of the event participants with respect to the event.

As a configuration example, it is possible to provide a program to be executed by a computer. The program is executed by, for example, a processor of a computer constituting the second information processing terminal A2.

The program is a program for causing the computer to execute: acquiring the event invitation information associated with the event identification information generated based on the information from the first information processing terminal A1; transmitting the second input content during the event period associated with the event identification information; and transmitting, during the event period, the first request for requesting the monitor 12 configured to display the first output content, which is generated by the plurality of first input contents acquired from the first information processing terminal A1 and is associated with the event identification information, to display the second output content generated based on the second input content.

Therefore, in the program, the second information processing terminal A2 that has acquired the event invitation information can transmit the second input content and the first request to the information processing terminal 11 to make the monitor 12 perform the interrupted display of the second output content.

Accordingly, in the program, since the event participant can add the content to be displayed by the monitor 12, it is possible to enhance the sense of unity of the event participants with respect to the event.

A second embodiment will be described.

In the present embodiment, configurations and operations different from those of the first embodiment will be mainly described, and detailed description of configurations and operations substantially the same as those of the first embodiment will be omitted.

In the present embodiment, processing performed by the information processing terminal 11, the monitor 12, the first information processing terminal A1 operated by the first user B1, the second information processing terminal A2 operated by the second user B2, and the third information processing terminal A3 operated by the third user B3 illustrated in FIG. 1 will be described.

Note that in the processing according to the present embodiment, the fourth information processing terminal A4 is not required to be provided.

In the present embodiment, the information processing terminal 11, the monitor 12, the first information processing terminal A1, and the second information processing terminal A2 respectively store and execute predetermined application programs substantially the same as those in the first embodiment.

Further, in the present embodiment, it is assumed that case where the third information processing terminal A3 does not store a predetermined application program for executing the processing according to the present embodiment. Note that although the third information processing terminal A3 may store such an application program, when such an application program is not used will be described in the present embodiment.

In the present embodiment, for the sake of convenience of explanation, content supplied from the third information processing terminal A3 is referred to as third input content, and content displayed on the monitor 12 based on the third input content is referred to as third output content.

In the present embodiment, the third user B3 is a family or an acquaintance of the second user B2.

The third user B3 is not invited to the home party, which is an event, but participates in the home party together with the second user B2.

For example, in the first embodiment, when the second information processing terminal A2 transmits the content display request to the information processing terminal 11 is described. However, when a group such as a family participates in an event, it may be desired to make a content display request from an apparatus other than the second information processing terminal A2 of the second user B2 invited to the event in some cases.

Therefore, in the present embodiment, an example of processing of making the content display request by the third information processing terminal A3 of the third user B3 who has not received the event invitation will be described.

The display system 1 executes five types of processing of generating an event, storing the first input content, starting the event, displaying the third output content based on the third input content, and ending the event.

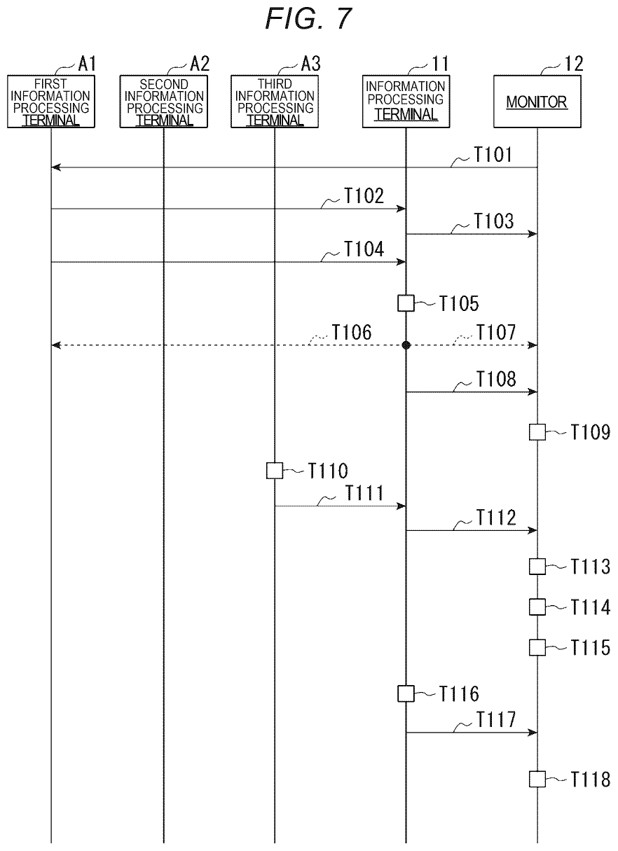

FIG. 7 is a diagram showing an example of a flow of the processing performed in the display system 1 according to the second embodiment.

FIG. 7 schematically illustrates the information processing terminal 11, the monitor 12, the first information processing terminal A1, the second information processing terminal A2, and the third information processing terminal A3.

A procedure of generating the event will be described.

The procedure of generating the event is substantially the same as the procedure of the processing T1 to the processing T8 in the first embodiment.

Note that in the example of FIG. 7, the procedure of these types of processing is omitted from the illustration.

A procedure for storing the first input content will be described.

The procedure of storing the first input content is substantially the same as the procedure of the processing T9 to the processing T11 in the first embodiment.

Note that in the example of FIG. 7, the procedure of these types of processing is omitted from the illustration.

A procedure for starting the event will be described.

The first information processing terminal A1 is connected to the monitor 12 via wireless communication with the network C1.

In processing T101, the monitor 12 transmits the monitor ID to the first information processing terminal A1.

In processing T102, the first information processing terminal A1 transmits the monitor ID to the information processing terminal 11.

In processing T103, the information processing terminal 11 establishes the wireless communication with the monitor 12 based on the monitor ID.

In processing T104, the first information processing terminal A1 selects the event ID and the monitor ID, and transmits the event ID, the event start request, and the monitor ID to the information processing terminal 11.

In processing T105, upon reception of the event start request, the information processing terminal 11 acquires information related to the corresponding event date and time from the storage unit 114, and determines whether the event date and time acquired are reached.

As a result, when the information processing terminal 11 determines that the event date and time are not reached, the information processing terminal 11 transmits the fact that the event is not started to the first information processing terminal A1 in processing T106, and ends the processing of the procedure of starting the event.

On the other hand, when the information processing terminal 11 determines that the event date and time are reached, the information processing terminal 11 acquires the plurality of images and the selection order information from the storage unit 114 and transmits the plurality of images and the selection order information to the monitor 12 in processing T107.

Here, either one of the processing T106 and the processing T107 is performed. Note that in the example of FIG. 7, processing after the processing T107 is also illustrated for the sake of convenience of explanation, but when the processing T106 is performed, subsequent processing is not performed.

In processing T108, the information processing terminal 11 generates a two-dimensional code associated with the event ID and transmits the two-dimensional code to the monitor 12.

Here, the two-dimensional code includes information for accessing a website provided by the information processing terminal 11. The information may be, for example, information of a uniform resource locator (URL).

Note that as the two-dimensional code, for example, a QR code (registered trademark) may be used.

In processing T109, the monitor 12 rearranges the plurality of images received based on the selection order information, and adds delimiter information to the boundary between the images to thereby generate the first output content. Then, the monitor 12 displays the first output content and the two-dimensional code overlapping the first output content.

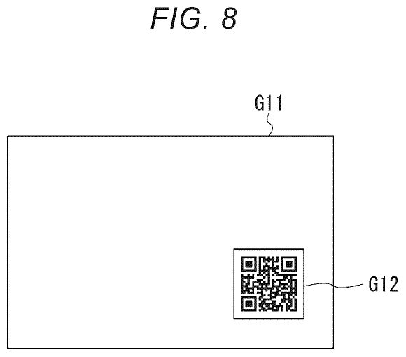

FIG. 8 is a diagram showing an example of display of the first output content and the two-dimensional code according to the second embodiment.

In the example of FIG. 8, an eleventh image G11 is displayed, and a twelfth image G12 is displayed so as to overlap a part of the eleventh image G11.

Here, the eleventh image G11 is an image of the first output content.

The twelfth image G12 is an image of the two-dimensional code.

Note that the image of the first output content and the image of the two-dimensional code may be displayed in an overlapping manner at any locations, for example. As another example, the image of the first output content and the image of the two-dimensional code may be simultaneously displayed on the same screen of the screen 21 in a form of not overlapping each other.

Here, when the monitor 12 displays the two-dimensional code is described in the present embodiment, but as another example, the two-dimensional code may be displayed by another apparatus. The other apparatus may be, for example, the first information processing terminal A1 or the second information processing terminal A2.

Further, when the image of the two-dimensional code overlaps the image of the first output content is described in the present embodiment, but as another example, the image of the two-dimensional code may overlap another image. The other image may be an image of, for example, the second output content.

A procedure of displaying the third output content based on the third input content will be described.

In processing T110, the third information processing terminal A3 reads the two-dimensional code displayed by the monitor 12, and displays the information of the website provided by the information processing terminal 11 using the two-dimensional code.

Here, the reading of the two-dimensional code may be performed by, for example, the third user B3 operating the third information processing terminal A3.

In processing T111, the third information processing terminal A3 displays a list of moving images or still images stored in the third storage unit E43.

Then, the third information processing terminal A3 transmits the image selected by the operation of the third user B3 and the content display request to the information processing terminal 11 via the website.

Here, the image may be, for example, a moving image or a still image.

In processing T112, the information processing terminal 11 transmits the image, which is received from the third information processing terminal A3, to the monitor 12.

In processing T113, the monitor 12 generates the third output content based on the image thus received and stores the third output content in the display storage unit 214.

Here, for example, when the image is a still image, the monitor 12 may generate the third output content as content for displaying the still image for a predetermined period.

In the present embodiment, the monitor 12 generates the third output content from the third input content.

In processing T114, the monitor 12 acquires the reproduction time information of the first output content, and stores the delimiter information posterior to the reproduction time information and the closest to the reproduction time in the display storage unit 214.

In processing T115, the monitor 12 displays the first output content up to the delimiter information thus stored.

Subsequently, the monitor 12 displays the third output content.

Then, after the display of the third output content is completed, the monitor 12 displays the first output content posterior to the delimiter information based on the delimiter information acquired from the display storage unit 214.

A procedure for ending the event will be described.

In the present embodiment, after the information processing terminal 11 receives the event start request and then determines that the event date and time are reached, the information processing terminal 11 acquires the information related to the event date and time from the storage unit 114 and determines whether the event date and time pass every time a predetermined period elapses.

As a result, when the information processing terminal 11 determines that the event date and time do not pass, the information processing terminal 11 ends the processing of the procedure for ending the event in processing T116.

On the other hand, when the information processing terminal 11 determines that the date and time pass, the information processing terminal 11 transmits event end information to the monitor 12 in processing T117.

In processing T118, upon reception of the event end information, the monitor 12 stops displaying the first output content or the third output content.

Here, in the present embodiment, the display storage unit 214 of the monitor 12 stores the first output content and the third output content.

The first output content is content including a plurality of images uploaded to the information processing terminal 11 by the first information processing terminal A1.

The third output content is content including one image uploaded to the information processing terminal 11 by the third information processing terminal A3.

As described above, in the display system 1 according to the present embodiment, the sense of unity of the event participants with respect to the event can be enhanced.

As a configuration example, in the control method of the information processing terminal 11, the following processing is performed.

In the method of controlling the information processing terminal 11, when the second request is acquired during the event period from the third information processing terminal A3 that has not received the event invitation information via the website accessible during the event period, the monitor 12 is set to display the third output content by interrupting the display of the first output content.

Here, the second request requests the monitor 12 to display at least one content.

Further, the third output content is generated based on the third input content acquired from the third information processing terminal A3 via the website.

Note that in the present embodiment, the content display request is an example of the second request.

Therefore, in the method of controlling the information processing terminal 11, by the third information processing terminal A3 transmitting the second request and the third input content to the information processing terminal 11 via the website during the event period, the monitor 12 performs the interrupted display for displaying the third output content generated based on the third input content.

Accordingly, in the method of controlling the information processing terminal 11, since it is possible to make the monitor 12 display a still image or the like taken by a smartphone or the like owned by an event participant who does not receive the event invitation information, such as a family member of the user who received the event invitation information via the browser, it is possible to increase the sense of unity of the event participants with respect to the event even for the event participant who has not received the event invitation information.

Note that the image taking may be referred to as, for example, imaging or acquisition of an image.

Here, in the present embodiment, an attendant who has not received the event invitation information but is attending the event is also regarded as an event participant.

Further, the website is not particularly limited, and for example, a specific website generated by the information processing terminal 11 or the like may be used.

As a configuration example, the following configuration is adopted in the display system 1.

The display system 1 includes the third information processing terminal A3 that has not received the event invitation information.

When the information processing terminal 11 acquires, during the event period, the second request for requesting the monitor 12 to display at least one content via the website accessible from the third information processing terminal A3 during the event period, the information processing terminal 11 makes the monitor 12 display the third output content generated based on the third input content acquired from the third information processing terminal A3 via the website by interrupting the display of the first output content.

Therefore, in the display system 1, by the third information processing terminal A3 transmitting the second request and the third input content to the information processing terminal 11 via the website during the event period, the monitor 12 performs the interrupted display for displaying the third output content generated based on the third input content.

Accordingly, in the display system 1, since it is possible to make the monitor 12 display a still image or the like captured by a smartphone or the like owned by an event participant who does not receive the event invitation information, such as a family member of the user who received the event invitation information via the browser, it is possible to increase the sense of unity of the event participants with respect to the event even for the event participant who has not received the event invitation information.

As a configuration example, the following configuration is adopted in the display system 1.

The third information processing terminal A3 acquires the two-dimensional code. Here, the two dimensional code includes address information of the website. Further, the two-dimensional code is displayed during the event period by at least one of the monitor 12, the first information processing terminal A1, and the second information processing terminal A2.

The third information processing terminal A3 transmits the second request via the website based on the address information.

Therefore, in the display system 1, the third information processing terminal A3 can transmit the second request to the information processing terminal 11 by acquiring the two-dimensional code including the address information of the website during the event period.

As a result, in the display system 1, it is possible to improve security with respect to access to the information processing terminal 11 compared to, for example, a method of printing the address information of the website on a paper medium or a method of transmitting the address information of the website to the third information processing terminal A3 in a format such as an e-mail. For example, by adopting an arrangement in which the t two-dimensional code is displayed on a predetermined display screen at an event site, the security can be improved.

Note that as another example, the method of printing the address information of the website on the paper medium or the method of transmitting the address information of the website to the third information processing terminal A3 in the form of an e-mail or the like may be used.

Here, the address information of the website is information such as a URL of the website.

Note that the address information of the website may be updated by the information processing terminal 11 or the like, for example, every time a predetermined period elapses.

A third embodiment will be described.

In the present embodiment, configurations and operations different from those of the first embodiment will be mainly described, and detailed description of configurations and operations substantially the same as those of the first embodiment will be omitted.

In the present embodiment, processing performed by the information processing terminal 11, the monitor 12, the first information processing terminal A1 operated by the first user B1, the second information processing terminal A2 operated by the second user B2, and the fourth information processing terminal A4 operated by the fourth user B4 illustrated in FIG. 1 will be described.

Note that in the processing according to the present embodiment, the third information processing terminal A3 is not required to be provided.

In the present embodiment, the information processing terminal 11, the monitor 12, the first information processing terminal A1, and the second information processing terminal A2 respectively store and execute predetermined application programs substantially the same as those in the first embodiment.

Further, in the present embodiment, the fourth information processing terminal A4 stores a predetermined application program for executing the processing according to the present embodiment in the fourth storage unit E44, and executes the application program with the fourth control unit E54. In the present embodiment, the application program is a program for a smartphone.

In the present embodiment, for the sake of convenience of explanation, content supplied from the fourth information processing terminal A4 is referred to as fourth input content, and content displayed on the monitor 12 based on the second input content and the fourth input content is referred to as fifth output content.

In the present embodiment, the fourth user B4 is invited to a home party that is an event.

For example, in the first embodiment, when the second information processing terminal A2 transmits the content display request to the information processing terminal 11 is described.

However, when apparatuses of a plurality of users transmit content display requests to the information processing terminal 11 in the same period, a period in which the first output content is not displayed becomes long since the plurality of contents are continuously displayed, and there is a possibility that the spatial presentation by the event organizer is hindered. On the other hand, when the plurality of contents is sequentially displayed in accordance with the delimiter information, there is a possibility that the sense of unity of the event participants with respect to the event cannot be enhanced since the intention of the user who transmitted the content display request is not immediately reflected.

Therefore, in the present embodiment, an example of content display processing when the apparatuses of the plurality of users transmit content display requests to the information processing terminal 11 in the same period will be described.

The display system 1 executes five types of processing of generating an event, storing the first input content, starting the event, displaying the fifth output content based on the second input content and the fourth input content, and ending the event.

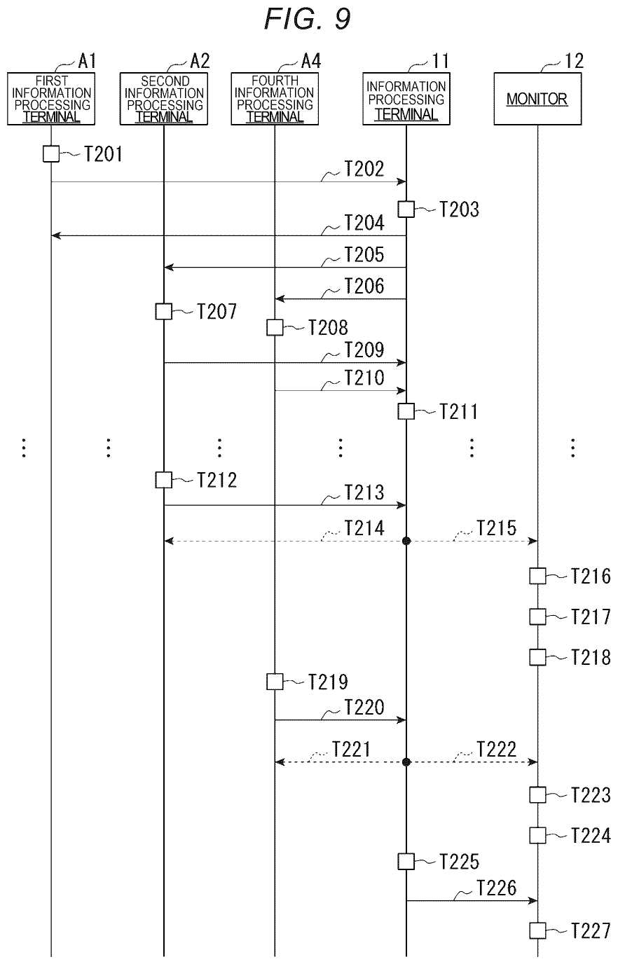

FIG. 9 is a diagram showing an example of a flow of the processing performed in the display System 1 according to the third embodiment.

FIG. 9 schematically illustrates the information processing terminal 11, the monitor 12, the first information processing terminal A1, the second information processing terminal A2, and the fourth information processing terminal A4.

A procedure of generating the event will be described.

In processing T201, the first information processing terminal A1 acquires an event generation request by an operation of the first user B1.

In processing T202, the first information processing terminal A1 transmits information related to the event date and time acquired by the operation of the first user B1, information related to the invitee, the event generation request, and an organizer user ID to the information processing terminal 11.

In processing T203, when the information processing terminal 11 receives the information related to the event date and time, the information related to the invitee, the event generation request, and the organizer user ID, the information processing terminal 11 generates an event ID. Then, the information processing terminal 11 stores the event ID in the storage unit 114 in association with the information related to the event date and time, the information related to the invitee, and the organizer user ID.

In processing T204, the information processing terminal 11 transmits the event ID to the first information processing terminal A1.

In processing T205 and processing T206, the information processing terminal 11 extracts the invitee user ID corresponding to the invitee from the storage unit 114 based on the information related to the invitee, and transmits an event invitation to the invitee.

Here, in the present embodiment, the invitees include the second user B2 and the fourth user B4.

In this example, the information processing terminal 11 transmits the event invitation to the second information processing terminal A2 of the second user B2 in the processing T205, and transmits the event invitation to the fourth information processing terminal A4 of the fourth user B4 in the processing T206.

In processing T207, the second information processing terminal A2 notifies the second user B2 of the fact that the event invitation has been received.

In processing T208, the fourth information processing terminal A4 notifies the fourth user B4 of the fact that the event invitation has been received.

In processing T209, the second information processing terminal A2 transmits event attendance information or event absence information acquired by the operation of the second user B2 and the invitee user ID to the information processing terminal 11.

In processing T210, the fourth information processing terminal A4 transmits event attendance information or event absence information acquired by the operation of the fourth user B4 and the invitee user ID to the information processing terminal 11.

In processing T211, the information processing terminal 11 stores the event attendance information or the event absence information and the invitee user ID in the storage unit 114 in association with the event ID.

A procedure for storing the first input content will be described.

The procedure of storing the first input content is substantially the same as the procedure of the processing T9 to the processing T11 in the first embodiment.

Note that in the example of FIG. 9, the procedure of these types of processing is omitted from the illustration.

A procedure for starting the event will be described.

The procedure of starting the event is substantially the same as the procedure of the processing T12 to the processing T19 in the first embodiment.

Note that in the example of FIG. 9, the procedure of these types of processing is omitted from the illustration.

A procedure of displaying the fifth output content based on the second input content and the fourth input content will be described.

In processing T212, the second information processing terminal A2 selects the event ID. Then, the second information processing terminal A2 displays a list of moving images or still images stored in the second storage unit E42.

Here, the event ID may be selected by, for example, an operation of the second user B2 or may be automatically selected by the second information processing terminal A2.

In processing T213, the second information processing terminal A2 transmits the image selected by the operation of the second user B2 and the content display request to the information processing terminal 11.

Here, the image may be, for example, a moving image or a still image.

When the information processing terminal 11 receives the content display request, the information processing terminal 11 acquires the information related to the event date and time from the storage unit 114, and determines whether the event date and time are reached.

As a result, when the information processing terminal 11 determines that the event date and time are not reached, the information processing terminal 11 transmits the fact that it is not in the event period to the second information processing terminal A2 in processing T214, and ends the processing of the procedure of displaying the content.

On the other hand, when the information processing terminal 11 determines that the event date and time are reached, the information processing terminal 11 transmits the image, which is received from the second information processing terminal A2, to the monitor 12 in processing T215.

Here, either one of the processing T214 and the processing T215 is performed. Note that in the example of FIG. 9, processing after the processing T215 is also illustrated for the sake of convenience of explanation, but when the processing T214 is performed, subsequent processing is not performed.

In processing T216, the monitor 12 generates the second output content based on the image thus received and stores the second output content in the display storage unit 214.

In processing T217, the monitor 12 acquires the reproduction time information of the first output content, and stores the delimiter information posterior to the reproduction time information and the closest to the reproduction time in the display storage unit 214.

In processing T218, the monitor 12 displays the first output content up to the delimiter information thus stored.

At this point, the monitor 12 determines whether to receive the image, which is transmitted from the fourth information processing terminal A4, from the information processing terminal 11 during a period from when the image, which is transmitted from the second information processing terminal A2, is received from the information processing terminal 11 to when the first output content up to the subsequent delimiter information is displayed.

In this example, the image and the content display request are transmitted from the fourth information processing terminal A4 in time for such a period.

In processing T219, the fourth information processing terminal A4 selects the event ID. Then, the fourth information processing terminal A4 displays a list of moving images or still images stored in the fourth storage unit E44.

Here, the event ID may be selected by, for example, an operation of the fourth user B4, or may be automatically selected by the fourth information processing terminal A4.

In processing T220, the fourth information processing terminal A4 transmits the image selected by the operation of the fourth user B4 and the content display request to the information processing terminal 11.

Here, the image may be, for example, a moving image or a still image.

Here, in this example, the same event ID is selected in the second information processing terminal A2 and the fourth information processing terminal A4.

Further, in this example, when the content display request is transmitted from the fourth information processing terminal A4 to the information processing terminal 11 slightly after the content display request is transmitted from the second information processing terminal A2 to the information processing terminal 11 will be described.

When the information processing terminal 11 receives the content display request, the information processing terminal 11 acquires the information related to the event date and time from the storage unit 114, and determines whether the event date and time are reached.

As a result, when the information processing terminal 11 determines that the event date and time are not reached, the information processing terminal 11 transmits the fact that it is not in the event period to the fourth information processing terminal A4 in processing T221, and ends the processing of the procedure of displaying the content.

On the other hand, when the information processing terminal 11 determines that the event date and time are reached, the information processing terminal 11 transmits the image, which is received from the fourth information processing terminal A4, to the monitor 12 in processing T222.

Here, either one of the processing T221 and the processing T222 is performed. Note that in the example of FIG. 9, processing after the processing T222 is also illustrated for the sake of convenience of explanation, but when the processing T221 is performed, subsequent processing is not performed.

When the monitor 12 receives the image, which is transmitted from the fourth information processing terminal A4, from the information processing terminal 11, the monitor 12 generates the fifth output content based on the image transmitted from the second information processing terminal A2 and the image transmitted from the fourth information processing terminal A4 and stores the fifth output content in the display storage unit 214 in processing T223.

Here, when the monitor 12 receives the image, which is transmitted from the fourth information processing terminal A4, from the information processing terminal 11 during a period from when the image transmitted from the second information processing terminal A2 is received from the information processing terminal 11 to when the first output content up to the subsequent delimiter information is displayed, the monitor 12 displays the fifth output content from the timing of the subsequent delimiter information in processing T224.

Then, after the display of the fifth output content is completed, the monitor 12 displays the first output content posterior to the delimiter information based on the delimiter information acquired from the display storage unit 214.

That is, in the monitor 12, the reproduction of the first output content is temporarily stopped at the location of the delimiter information provided to the first output content in reproduction, the fifth output content is reproduced instead by interruption, and then the reproduction of the first output content is resumed from the location of the delimiter information.

Note that when the monitor 12 does not receive the image, which is transmitted from the fourth information processing terminal A4, from the information processing terminal 11 during a period from when the monitor 12 receives the image, which is transmitted from the second information processing terminal A2, from the information processing terminal 11 to when the monitor 12 displays the first output content up to the subsequent delimiter information, the monitor 12 performs the interrupted display of the second output content similarly to the case of the first embodiment. Then, after the display of the second output content is completed, the monitor 12 displays the first output content posterior to the delimiter information based on the delimiter information acquired from the display storage unit 214.

A procedure for ending the event will be described.

In the present embodiment, after the information processing terminal 11 receives the event start request and then determines that the event date and time are reached, the information processing terminal 11 acquires the information related to the event date and time from the storage unit 114 and determines whether the event date and time pass every time a predetermined period elapses.

As a result, when the information processing terminal 11 determines that the event date and time do not pass, the information processing terminal 11 ends the processing of the procedure for ending the event in processing T225.

On the other hand, when the information processing terminal 11 determines that the date and time pass, the information processing terminal 11 transmits event end information to the monitor 12 in processing T226.

In processing T227, upon reception of the event end information, the monitor 12 stops displaying the first output content, the second output content, or the fifth output content.

Here, in the present embodiment, the display storage unit 214 of the monitor 12 stores the first output content, the second output content, and the fifth output content.

The first output content is content including a plurality of images uploaded to the information processing terminal 11 by the first information processing terminal A1.

The second output content is content including one image uploaded to the information processing terminal 11 by the second information processing terminal A2.

The fifth output content includes, for example, one image uploaded to the information processing terminal 11 by the second information processing terminal A2 and one image uploaded to the information processing terminal 11 by the fourth information processing terminal A4.

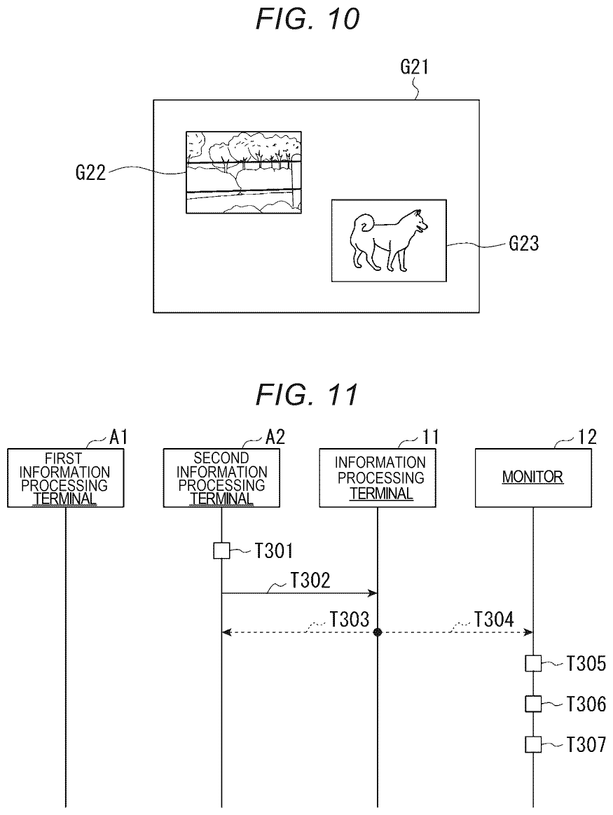

FIG. 10 is a diagram showing an example of the fifth output content according to the third embodiment.

In the example of FIG. 10, a twenty-first image G21 is displayed.

The twenty-first image G21 includes a twenty-second image G22 and a twenty-third image G23.

Here, the twenty-first image G21 is an image of the fifth output content.

Further, the twenty-second image G22 is an image of the second input content.

Further, the twenty-third image G23 is an image of the fourth input content.

A method of generating the fifth output content using the second input content and the fourth input content is not particularly limited, and various methods may be used. For example, any arrangement may be adopted as an arrangement of the image of the second input content and the image of the fourth input content in the image of the fifth output content.

Note that generating the output content using a plurality of different input contents may be referred to as, for example, integration, synthesis, or combination.

Note that when the image and the content display request are transmitted from the fourth information processing terminal A4 to the information processing terminal 11 while the image and the content display request are not transmitted from the second information processing terminal A2 to the information processing terminal 11, the output content based on the fourth input content is displayed by the monitor 12 similarly to when the image and the content display request are transmitted from the second information processing terminal A2 to the information processing terminal 11 while the image and the content display request are not transmitted from the fourth information processing terminal A4 to the information processing terminal 11.

In this case, the display storage unit 214 of the monitor 12 stores the first output content and the output content based on the fourth input content.

In addition, in the present embodiment, there is described when the monitor 12 generates and then displays the output content based on two images when the content display requests of the two images are received from two apparatuses in a predetermined period, but as another example, when the image content display requests of images are received from three or more apparatuses in the predetermined period, the output content based on these three or more images may be generated and displayed by the monitor 12.

As described above, in the display system 1 according to the present embodiment, the sense of unity of the event participants with respect to the event can be enhanced.

As a configuration example, in the control method of the information processing terminal 11, the following processing is performed.

In the method of controlling the information processing terminal 11, processing of transmitting the event invitation information associated with the event identification information to the fourth information processing terminal A4 is performed.

In the method of controlling the information processing terminal 11, when the first request is acquired and the third request for requesting the monitor 12 to display at least one content is acquired from the fourth information processing terminal A4 during the second period in the event period, processing of causing the monitor 12 to display the fifth output content generated based on the second input content acquired from the second information processing terminal A2 and the fourth input content acquired from the fourth information processing terminal A4 by interrupting the display of the first output content is performed.

Note that in the present embodiment, the content display request acquired by the information processing terminal 11 from the fourth information processing terminal A4 is an example of the third request.

Therefore, in the display system 1, it is possible to perform interrupted display in which the fifth output content is generated based on the second input content and the fourth input content transmitted by the second information processing terminal A2 and the fourth information processing terminal A4 during the predetermined period, and is then displayed by the monitor 12.

Accordingly, in the display system 1, even when a plurality of users such as the event participant who owns the second information processing terminal A2 and the event participant who wns the fourth information processing terminal transmit still images or moving images to the information processing terminal 11 in the same period, it is possible to shorten the period in which the first output content is not displayed due to the interrupted display. Therefore, in the display system 1, the period in which the spatial rendering effect intended by the event organizer with the first output content is impaired can be suppressed while increasing the sense of unity of the event participants with respect to the event.

Here, the second period represents, for example, a period from when the monitor 12 receives the second input content transmitted from the second information processing terminal A2 to when the monitor 12 displays the first output content up to the delimiter information.

In the present embodiment, when a plurality of users transmit contents to the information processing terminal 11 in the same period, the monitor 12 can generate the content in which the plurality of contents acquired during a predetermined period are collected and perform the interrupted display.

Here, a combination of the second embodiment and the third embodiment will be described.

That is, the third input content transmitted by the third information processing terminal A3 to the information processing terminal 11 via the website as in the second embodiment can be used instead of the fourth input content in the third embodiment.

In this case, the monitor 12 generates the fifth output content based on the second input content from the second information processing terminal A2 and the fourth input content from the fourth information processing terminal A4 and performs the interrupted display of the fifth output content in the third embodiment, but instead, the monitor 12 can generate the output content based on the second input content from the second information processing terminal A2 and the third input content from the third information processing terminal A3 and can perform the interrupted display of the output content.

A first modified example will be described.

A modified example of the processing of generating the second output content based on the moving image or the still image in the procedure of displaying the second output content according to the first embodiment will be described.

The monitor 12 may generate the second output content by adding highlighted display content to the moving image or the still image.

Here, the highlighted content is not particularly limited, and may be, for example, a frame or an animation. That is, an image having a frame may be generated as the second output content, or an image having an animation may be generated as the second output content.

Note that any aspect may be used as a shape, a size, a color, an arrangement, and so on of the frame.

Further, as the animation, any aspect may be used, and for example, an animation in which a predetermined picture moves in a predetermined manner may be used.

As described above, in the display system 1 according to the present example, the sense of unity of the event participants with respect to the event can be enhanced.

In the present example, by highlighting the second output content, for example, it is possible to notify the event participant of the fact that content different from the first output content is displayed, and thus it is possible to attract the interest of the event participant.

A second modified example will be described.

In the present example, configurations and operations different from those of the first embodiment will be mainly described, and detailed descriptions of configurations and operations substantially the same as those of the first embodiment will be omitted.

When the second user B2 in the first embodiment is a person in charge of a camera arranged in the event will be described.

In the event, there is a possibility that the second information processing terminal A2 of the second user B2 who is the person in charge of the camera is higher in frequency of making the content display request to the information processing terminal 11 compared to other participants. Therefore, in the procedure of the processing according to the first embodiment, there is a possibility that the work load when the person in charge of the camera executes the procedure for displaying the second output content increases.

Therefore, in the present example, when a first imaging mode M1 for the person in charge of the camera is prepared and used will be described.

Note that in the present example, the second information processing terminal A2 is an apparatus having a camera, and is not necessarily required to be a smartphone, and may be, for example, a camera itself.

A procedure of displaying the second output contents based on the second input contents will be described.

FIG. 11 is a diagram showing an example of a flow of processing according to the second modified example.

In processing T301, the second information processing terminal A2 selects the event ID. Further, the second information processing terminal A2 receives selection of the first imaging mode M1 in the application program based on an operation of the second user B2.

When the first imaging mode M1 is turned on, the second information processing terminal A2 continues to activate the camera of the second information processing terminal A2 in the application program during the period of the first imaging mode M1.

Here, the event ID may be selected by, for example, an operation of the second user B2 or may be automatically selected by the second information processing terminal A2.

Further, switching between ON and OFF of the first imaging mode MI may be instructed by, for example, an operation of the second user B2.

During the period of the first imaging mode M1, when the image taken by the camera is stored in the second storage unit E42, the second information processing terminal A2 transmits the image thus stored and the content display request to the information processing terminal 11 in processing T302.

Here, the image may be, for example, a moving image or a still image.

When the information processing terminal 11 receives the content display request, the information processing terminal 11 acquires the information related to the event date and time from the storage unit 114, and determines whether the event date and time are reached.

As a result, when the information processing terminal 11 determines that the event date and time are not reached, the information processing terminal 11 transmits the fact that it is not in the event period to the second information processing terminal A2 in processing T303, and ends the processing of the procedure of displaying the second output content based on the second input content.

On the other hand, when the information processing terminal 11 determines that the event date and time are reached, the information processing terminal 11 transmits the image, which is received from the second information processing terminal A2, to the monitor 12 in processing T304.

Here, either one of the processing T303 and the processing T304 is performed. Note that in the example of FIG. 11, processing after the processing T304 is also illustrated for the sake of convenience of explanation, but when the processing T303 is performed, subsequent processing is not performed.

In processing T305, the monitor 12 generates the second output content based on the image thus received and stores the second output content in the display storage unit 214.

Here, for example, when the image is a still image, the monitor 12 may generate the second output content as content for displaying the still image for a predetermined period.

In processing T306, the monitor 12 acquires the reproduction time information of the first output content, and stores the delimiter information posterior to the reproduction time information and the closest to the reproduction time in the display storage unit 214.

In processing T307, the monitor 12 displays the first output content up to the delimiter information thus stored.

Subsequently, the monitor 12 displays the second output content.

Then, after the display of the second output content is completed, the monitor 12 displays the first output content posterior to the delimiter information based on the delimiter information acquired from the display storage unit 214.

Here, in the present example, the camera is activated in the application program in the second information processing terminal A2, but as another example, a configuration of activating a camera application stored in a smartphone may be used.

As described above, in the display system according to the present example, the sense of unity of the event participants with respect to the event can be enhanced.

As one configuration example, in the display system 1, when the second information processing terminal A2 set to the first imaging mode MI receives an imaging operation, the second information processing terminal A2 transmits the second input content acquired based on the first request and the imaging operation.

Here, the imaging operation may be, for example, an operation of pressing a predetermined button of the camera. The predetermined button may be, for example, a button for giving an instruction to take a still image or a button for giving an instruction to take a moving image.

Therefore, in the display system 1, by setting the second information processing terminal A2 in the first imaging mode M1, the second information processing terminal A2 executes imaging processing, transmission processing of the first request which is the content display request, and transmission processing of the second input content as series of processing when the second information processing terminal A2 receives the imaging operation from the second user B2.

As a result, in the display system 1, the event participant who Owns the second information processing terminal A2 can omit the operation of the content display request by the second user B2 by setting the second information processing terminal A2 in the first imaging mode, and the work load of the event participant who is assigned to the person in charge of imaging can be suppressed. Therefore, in the display system 1, for example, it is possible to support an event participant who is assigned to the person in charge of imaging to enjoy the event.

Note that when the first imaging mode M1 is set OFF, in the second information processing terminal A2, the second user B2 can execute the transmission processing of the content display request and the transmission processing of the second input content with, for example, operations related to two types of processing procedures.

The first type of processing procedure is a processing procedure in which the content is stored in the memory of the second information processing terminal A2 by executing the imaging processing, and then the transmission processing of the content display request and the transmission processing of the second input content are executed by receiving the operation of selecting the content from the memory and receiving the operation of the content display request.

The second type of processing procedure is a processing procedure in which a selection operation of a camera icon is received in a predetermined display request screen in the second information processing terminal A2 to activate the camera and display the imaging screen, then the imaging processing is performed to store the content thus taken in the memory of the second information processing terminal A2, and then, the transmission processing of the content display request and the transmission processing of the second input content are executed by receiving the operation of the content display request.

Note that the memory of the second information processing terminal A2 may be, for example, the memory of the second storage unit E42 of the second information processing terminal A2.

A third modified example will be described.

In the present example, configurations and operations different from those of the first embodiment will be mainly described, and detailed descriptions of configurations and operations substantially the same as those of the first embodiment will be omitted.

In the present example, for the sake of convenience of explanation, the content displayed based on the plurality of second input contents is referred to as fourth output content.

In the second modified example, there is described the configuration in which the second information processing terminal A2 set to the first imaging mode M1 transmits the content display request to the information processing terminal 11 when the second information processing terminal stores the moving image or the still image.

In such a configuration, there is a possibility that the transmission frequency of the second input content transmitted to the monitor 12 increases.

Therefore, in the present example, a procedure of processing capable of suppressing the transmission frequency of the second input content will be described.

A procedure of displaying the fourth output content based on the second input content will be described.

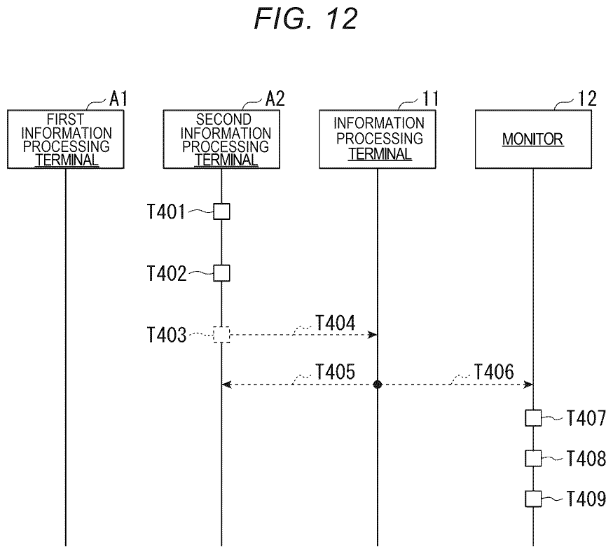

FIG. 12 is a diagram showing an example of a flow of processing according to the third modified example.

In processing T401, the second information processing terminal A2 selects the event ID. Further, the second information processing terminal A2 receives selection of a second imaging mode M2 in the application program based on an operation of the second user B2.

When the second imaging mode M2 is turned on, the second information processing terminal A2 continues to activate the camera of the second information processing terminal A2 in the application program during the period of the second imaging mode M2.

Here, the event ID may be selected by, for example, an operation of the second user B2 or may be automatically selected by the second information processing terminal A2.

Further, switching between ON and OFF of the second imaging mode M2 may be instructed by, for example, an operation of the second user B2.

During the period of the second imaging mode M2, the second information processing terminal A2 stores an image taken by the camera in the second storage unit E42. In the present example, the second information processing terminal A2 stores the image taken by the camera in a predetermined folder of the second storage unit E42.

Here, the image may be, for example, a moving image or a still image.

During the period of the second imaging mode M2, the second information processing terminal A2 determines whether one or more images are stored in the predetermined folder in processing T402 after a predetermined period elapses.

As a result, when the second information processing terminal determines that no image is stored in the predetermined folder, the second information processing terminal A2 ends the procedure of the processing of displaying the content in processing T403.

On the other hand, when the second information processing terminal A2 determines that one or more images are stored in the predetermined folder, the second information processing terminal A2 transmits all the images stored in the predetermined folder and the content display request to the information processing terminal 11 in processing T404. Then, the second information processing terminal A2 transfers the images stored in the predetermined folder to another folder. Note that the other folder may be a folder in which data to be erased is stored like a so-called trash box, or may be a folder for archive as another example.

Here, either one of the processing T403 and the processing T404 is performed. Note that in the example of FIG. 12, processing after the processing T404 is also illustrated for the sake of convenience of explanation, but when the processing T403 is performed, subsequent processing is not performed.

When the information processing terminal 11 receives the content display request, the information processing terminal 11 acquires the information related to the event date and time from the storage unit 114, and determines whether the event date and time are reached.

As a result, when the information processing terminal 11 determines that the event date and time are not reached, the information processing terminal 11 transmits the fact that it is not in the event period to the second information processing terminal A2 in processing T405, and ends the processing of the procedure of displaying the content.

On the other hand, when the information processing terminal 11 determines that the event date and time are reached, the information processing terminal 11 transmits the image, which is received from the second information processing terminal A2, to the monitor 12 in processing T406.

Here, either one of the processing T405 and the processing T406 is performed. Note that in the example of FIG. 12, processing after the processing T406 is also illustrated for the sake of convenience of explanation, but when the processing T405 is performed, subsequent processing is not performed.

In processing T407, the monitor 12 generates the output content based on the image thus received and stores the output content in the display storage unit 214.

Here, in the present example, when the monitor 12 receives a plurality of images at a time is assumed. In this case, the monitor 12 generates the fourth output content based on the plurality of images described above and stores the fourth output content in the display storage unit 214.

Note that as another example, when the monitor 12 receives a single image, the monitor 12 generates the second output content based on the image and stores the second output content in the display storage unit 214.

Here, for example, when the fourth output content includes a still image, the monitor 12 may generate the fourth output content as content having a region in which the still image is displayed for a predetermined time.

In processing T408, the monitor 12 acquires the reproduction time information of the first output content, and stores the delimiter information posterior to the reproduction time information and the closest to the reproduction time in the display storage unit 214.

In processing T409, the monitor 12 displays the first output content up to the delimiter information thus stored.

Subsequently, the monitor 12 displays the fourth output content.

Then, after the display of the fourth output content is completed, the monitor 12 displays the first output content posterior to the delimiter information based on the delimiter information acquired from the display storage unit 214.

Note that as another example, when the monitor 12 generates the second output content instead of the fourth output content, the monitor performs processing of performing the interrupted display of the second output content.

Here, in the present example, the camera is activated in the application program in the second information processing terminal A2, but as another example, a configuration of activating a camera application stored in a smartphone may be used.

As described above, in the display system 1 according to the present example, the sense of unity of the event participants with respect to the event can be enhanced.

As one configuration example, in the display system 1, when the second information processing terminal A2 set to the second imaging mode M2 receives the imaging operation, the second information processing terminal A2 stores the second input content in a predetermined folder.

The second information processing terminal A2 set to the second imaging mode M2 transmits the first request and the plurality of second input contents stored in the predetermined folder every time a third period elapses.

Then, the fourth output content generated based on the plurality of second input contents is displayed by interrupting the display of the first output content.

Here, the third period may be, for example, a predetermined period set in advance, and as a specific example, may be a period such as 5 [minutes] or 10 [minutes].

Therefore, in the display system 1, by setting the second information processing terminal A2 in the second imaging mode M2, the second information processing terminal A2 transmits the second input content stored in the predetermined folder to the information processing terminal 11 every time the predetermined period elapses.

Here, there is a high possibility that the event participant who owns the second information processing terminal A2 set to the second imaging mode M2 becomes higher in imaging frequency compared to other event participants.

In view of this, in the display system 1, even when the event participant who owns the second information processing terminal A2 set to the second imaging mode M2 takes a plurality of still images or moving images in a short time, by transmitting the plurality of images to the information processing terminal 11 every predetermined period, it is possible to shorten the period in which the first output content is not displayed due to the interrupted display. Therefore, in the display system 1, the spatial rendering effect intended by the event organizer with the first output content can be prevented from being impaired while increasing the sense of unity of the event participants with respect to the event.

In the present example, when the second information processing terminal A2 is set to the second imaging mode M2, the second information processing terminal A2 transmits the second content stored in the predetermined folder and the interrupt request for the second content to the information processing terminal 11 every e time the predetermined period elapses.

For example, since it is conceivable that the person in charge of the camera takes many images, the content transmission is collectively performed every time a certain period elapses so that the frequency of the content transmission does not excessively increase.

Here, when the second imaging mode M2 is in the ON state, for example, the second information processing terminal A2 automatically executes the transmission processing of the content display request, the transmission processing of the second input content, and the transfer processing of the content thus transmitted every time a predetermined period of time elapses, even when the second user B2 does not operate the screen of the user interface (UI).

In the transmission processing of the second input content, processing of transmitting the second input content stored in the predetermined folder is performed.

In the transfer processing of the transmitted content, processing of transferring the second input content stored in the predetermined folder to another folder such as a trash box folder is performed after the transmission processing of the second input content is performed.

Here, for example, in the first embodiment, the second modified example, or the third modified example, the following configuration may be adopted.

As one configuration example, in the method of controlling the information processing terminal 11, when the first request is acquired during the event period, the monitor 12 is set to display the fourth output content by interrupting the display of the first output content. Here, the fourth output content is generated based on a plurality of second input contents acquired from the second information processing terminal A2 during a first period.

Here, the first period represents, for example, a period from when the monitor 12 receives the second input content transmitted from the second information processing terminal A2 to when the monitor 12 displays the first output content up to the delimiter information.

Therefore, in the display system 1, it is possible to perform the interrupted display in which the fourth output content is generated based on the plurality of second input contents transmitted by the second information processing terminal A2 during the first period, and is displayed by the monitor 12.

Accordingly, in the display system 1, for example, even when the event participant who owns the second information processing terminal A2 transmits a plurality of still images or moving images to the information processing terminal 11 in a short time, it is possible to shorten the period in which the first output content is not displayed due to the interrupted display. Therefore, in the display system 1, the spatial rendering effect intended by the event organizer with the first output content can be prevented from being impaired while increasing the sense of unity of the event participants with respect to the event.

Here, the fourth output content is content obtained by integrating a plurality of still images or moving images transmitted by the second information processing terminal A2.

Further, the timing at which the second information processing terminal A2 transmits the plurality of still images or moving images to the information processing terminal 11 is not particularly limited, and for example, the second information processing terminal A2 may sequentially transmit the plurality of still images or moving images after the plurality of still images or moving images are selected, or a configuration in which the second information processing terminal A2 transmits the still images or the moving images a plurality of times together with the content display request within a predetermined period such as one minute.

In the present example, when one second user B2 transmits a plurality of second input contents from the second information processing terminal A2 to the information processing terminal 11 in a short period of time, the monitor 12 can generate the fourth output content in which the plurality of second input contents acquired during a predetermined period of time is collected and can perform the interrupted display.

Note that as an aspect of transmitting a plurality of second input contents from the second information processing terminal A2 to the information processing terminal 11 in a short period of time, for example, an aspect of transmitting the plurality of second input contents collectively and simultaneously or substantially simultaneously from the second information processing terminal A2 to the information processing terminal 11 may be used.

A fourth modified example will be described.

In the present example, configurations and operations different from those of the first embodiment will be mainly described, and detailed descriptions of configurations and operations substantially the same as those of the first embodiment will be omitted.

In the first embodiment, there is described when the first output content based on the first input content prepared in advance by the organizer of the event is repeatedly displayed by the monitor 12 during the event period, while the second output content, on which the interrupted display is performed in response to the content display request, is displayed by interruption only once at each content display request.

Therefore, in the present example, a procedure of processing of displaying the second output content related to the content display request many times even at one content display request will be described.

In the present example, the display system 1 executes five types of processing of generating an event, storing first input content, starting the event, displaying second output content based on second input content, adding the second output content to first output content, and ending the event.

Here, the presents example is schematically different from the first embodiment in that the second output content is added to the first output content after the second output content based on the second input content related to the first embodiment is displayed.

Note that another timing may be used as the timing at which the second output content is added to the first output content.

A procedure of adding the second output content to the first output content will be described.

In the present example, after the processing of displaying the second output content in response to the content display request from the second information processing terminal A2 is completed, the monitor 12 updates the first output content acquired from the display storage unit 214 with output content obtained by adding the second output content and the delimiter information to the first output content. Accordingly, the output content thus updated is stored in the display storage unit 214 as the updated first output content.

As described above, in the present example, the first output content which does not include the second output content is replaced with the updated first output content including the second output content. Accordingly, even at a single content display request, the second output content related to the content display request is repeatedly displayed together with the first output content.

Here, an aspect in which the second output content is added to the first output content is not particularly limited, and for example, an aspect in which the delimiter information is arranged after the first output content to be displayed once or a predetermined number of times no fewer than twice, and then the second output content to be displayed once or a predetermined number of times no fewer than twice is arranged may be used.

As described above, in the display system 1 according to the present example, the sense of unity of the event participants with respect to the event can be enhanced.

As one configuration example, in the method of controlling the information processing terminal 11, after causing the monitor 12 to display the second output content by interrupting the display of the first output content, the monitor 12 is set to display the first output content which is updated by adding the second input content.

Therefore, in the display system 1, the first output content is updated by adding the second input content transmitted by the second information processing terminal A2.

Thus, in the display system 1, by adding the still image or the moving image transmitted by the event participant to the first output content repeatedly displayed by the monitor 12 during the event period, the sense of unity of the event participants with respect to the event can be enhanced.

It is possible to record a program for implementing the function of any element in any apparatus described hereinabove on computer-readable recording medium, and make a computer system read and then execute the program. The “computer system” mentioned here includes an operating system or hardware such as peripheral equipment. The “computer-readable recording medium” is a portable medium such as a flexible disk, a magneto-optical disk, a read only memory (ROM), or a compact disc (CD)-ROM, or a storage device such as a hard disk incorporated in the computer system. Further, the “computer-readable recording medium” includes what retains a program for a certain period of time such as a volatile memory located inside the computer system serving as a server or a client when the program is transmitted via a network such as the Internet or a communication line such as a telephone line. The volatile memory may be a RAM. The recording medium may be a non-transitory recording medium.

The program described above may be transmitted from a computer system in which the program is stored in a storage device or the like to another computer system via a transmission medium or by a transmission wave in the transmission medium. The “transmission medium” for transmitting the program refers to a medium including a function of transmitting information like a network such as the Internet or a communication line such as a telephone line.

The program described above may be a program for implementing a part of the functions described above. The program described above may be a so-called differential file that can achieve the function described above in combination with a program already recorded on the computer system. The differential file may be referred to as a differential program.

The function of any element in any apparatus described hereinabove may be realized by a processor. Each processing in the embodiment may be realized by a processor that operates based on the information such as a program and a computer-readable recording medium that stores the information such as a program. In the processor, the function of each unit may be realized by individual hardware, or the function of each unit may be realized by integrated hardware. The processor may include hardware, and the hardware may include at least one of a circuit that processes a digital signal and a circuit that processes an analog signal. The processor may be configured using one or both of a single circuit device or a plurality of circuit devices mounted on a circuit board, and a single circuit element or a plurality of circuit elements. An integrated circuit (IC) or the like may be used as the circuit device, and a resistor, a capacitor, and so on may be used as the circuit element.

The processor may be a CPU. However, the processor is not limited to a CPU, and various processors such as a graphics processing unit (GPU) or a digital signal processor (DSP) may be used. The processor may be a hardware circuit using an application specific integrated circuit (ASIC). The processor may include a plurality of CPUs, or may include a hardware circuit including a plurality of ASICS. The processor may be configured with a combination of a plurality of CPUs and a hardware circuit including a plurality of ASICs. The processor may include one or more of an amplifier circuit, a filter circuit, or the like that processes an analog signal.

While the embodiment is hereinabove described in detail with reference to the drawings, the specific configurations are not limited to the embodiments, and include designs and the like without departing from the scope of the present disclosure.

### Summary of Present Disclosure

A summary of the present disclosure will be appended below.

### Appendix 1

A method of controlling an information processing terminal, the method including acquiring event identification information generated based on information from a first information processing terminal, causing a monitor to display first output content which is generated by a plurality of first input contents acquired from the first information processing terminal and is associated with the event identification information during an event period associated with the event identification information, and causing the monitor to display second output content generated based on second input content acquired from a second information processing terminal that has acquired event invitation information associated with the event identification information by interrupting the display of the first output content when a first request of requesting the monitor to display at least one content is acquired from the second information processing terminal during the event period.

Accordingly, since the event participant can add the content to be displayed by the monitor, it is possible to increase the sense of unity of the event participants with respect to the event.

### Appendix 2

The method of controlling the information processing terminal according to (Appendix 1), wherein the first request is rejected outside the event period.

Accordingly, it is possible to prevent the monitor from displaying the content requested by the event participant outside the event period.

### Appendix 3

The method of controlling the information processing terminal according to (Appendix 1) or (Appendix 2), wherein when a second request of requesting the monitor to display at least one content is acquired during the event period via a website accessible during the event period from a third information processing terminal that has not received the event invitation information, the monitor displays third output content generated based on third input content acquired from the third information processing terminal via the website by interrupting the display of the first output content.

Accordingly, since a still image or the like taken by the smartphone or the like owned by the event participant who has not received the event invitation information can be displayed by the monitor via the browser, it is possible to increase the sense of unity of the event participants with respect to the event even for the event participant who has not received the event invitation information.

### Appendix 4

The method of controlling the information processing terminal according to any one of (Appendix 1) to (Appendix 3), wherein when the first request is acquired during the event period, the monitor displays fourth output content generated based on a plurality of the second input contents acquired from the second information processing terminal during a first period by interrupting the display of the first output content.

Accordingly, for example, even when the event participant who owns the second information processing terminal transmits a plurality of still images or moving images to the information processing terminal in a short time, it is possible to shorten the period in which the first output content is not displayed due to the interrupted display. Therefore, the spatial rendering effect intended by the event organizer with the first output content can be prevented from being impaired while increasing the sense of unity of the event participants with respect to the event.

### Appendix 5

The method controlling the information processing terminal according to any one of (Appendix 1) to (Appendix 4), further including transmitting the event invitation information associated with the event identification information to a fourth information processing terminal, and causing the monitor to display fifth output content generated based on the second input content acquired from the second information processing terminal and fourth input content acquired from the fourth information processing terminal by interrupting the display of the first output content when the first request is acquired and a third request of requesting the monitor to display at least one content is acquired from the fourth information processing terminal during a second period in the event period.

Accordingly, even when a plurality of users such as the event participant who owns the second information processing terminal and the event participant who owns the fourth information processing terminal transmit still images or moving images to the information processing terminal in the same period, it is possible to shorten the period in which the first output content is not displayed due to the interrupted display. Therefore, the period in which the spatial rendering effect intended by the event organizer with the first output content is impaired can be suppressed while increasing the sense of unity of the event participants with respect to the event.

### Appendix 6

The method of controlling the information processing terminal according to any one of (Appendix 1) to (Appendix 5), wherein the monitor made to display the first output content updated by adding the second input content, the monitor displays the second output content by interrupting the display of the first output content.

Accordingly, by adding the still image or the moving image transmitted by the event participant to the first output content repeatedly displayed by the monitor during the event period, the sense of unity of the event participants with respect to the event can be enhanced.

### Appendix 7

A display system including
an information processing terminal, a first information processing terminal connected to the information processing terminal via a network, a second information processing terminal connected to the information processing terminal via the network, and a monitor connected to the information processing terminal via the network, wherein the information processing terminal acquires event identification information based on information from the first information processing terminal, makes the monitor display first output content which is generated by a plurality of first input contents acquired from the first information processing terminal and is associated with the event identification information in an event period associated with the event identification information, transmits event invitation information associated with the event identification information to the second information processing terminal, and makes the monitor display second output content generated based on second input content acquired from the second information processing terminal by interrupting the display of the first output content when a first request of requesting the monitor to display at least one content is acquired from the second information processing terminal during the event period.

Accordingly, since the event participant can add the content to be displayed by the monitor, it is possible to increase the sense of unity of the event participants with respect to the event.

### Appendix 8

The display system according to (Appendix 7), further including a third information processing terminal which has not received the event invitation information, wherein the information processing terminal makes the monitor display third output content generated based on third input content acquired from the third information processing terminal via a website by interrupting the display of the first output content when a second request of requesting the monitor to display at least one content is acquired during the event period via the website accessible during the event period from the third information processing terminal.

Accordingly, since a still image or the like taken by the smartphone or the like owned by the event participant who has not received the event invitation information can be displayed by the monitor via the browser, it is possible to increase the sense of unity of the event participants with respect to the event even for the event participant who has not received the event invitation information.

### Appendix 9

The display system according to (Appendix 8), wherein the third information processing terminal acquires a two-dimensional code which includes address information of the website and is displayed by at least one of the monitor, the first information processing terminal, and the second information processing terminal during the event period, and the third information processing terminal transmits the second request via the website based on the address information.

Thus, it is possible to improve security against access to the information processing terminal.

### Appendix 10

The display system according to any one of (Appendix 7) to (Appendix 9), wherein when the second information processing terminal set to a first imaging mode receives an imaging operation, the second information processing terminal transmits the first request and the second input content acquired based on the imaging operation.

As a result, the event participant who owns the second information processing terminal can omit the operation of the content display request by the second user by setting the second information processing terminal in the first imaging mode, and the work load of the event participant who is assigned to the person in charge of imaging can be suppressed. Therefore, for example, it is possible to support an event participant who is assigned to the person in charge of imaging to enjoy the event.

### Appendix 11

The display system according to any one of (Appendix 7) to (Appendix 10), wherein when the second information processing terminal set to a second imaging mode receives an imaging operation, the second information processing terminal stores the second input content in a folder, the second information processing terminal set to the second imaging mode transmits the first request and the plurality of second input contents stored in the folder every time a third period elapses, and fourth output content generated based on the plurality of second input contents is displayed by interrupting the display of the first output content.

Accordingly, even when the event participant who owns the second information processing terminal set to the second imaging mode takes a plurality of still images or moving images in a short time, by transmitting the plurality of images to the information processing terminal every predetermined period, it is possible to shorten the period in which the first output content is not displayed due to the interrupted display. Therefore, the spatial rendering effect intended by the event organizer with the first output content can be prevented from being impaired while increasing the sense of unity of the event participants with respect to the event.

### Appendix 12

A non-transitory computer-readable storage medium storing a program, the program including acquiring event invitation information associated with event identification information generated based on information from a first information processing terminal, transmitting second input content during an event period associated with the event identification information, and transmitting, during the event period, a first request for requesting a monitor configured to display first output content, which is generated by a plurality of first input contents acquired from the first information processing terminal and is associated with the event identification information, to display second output content generated based on the second input content.

Accordingly, since the event participant can add the content to be displayed by the monitor, it is possible to increase the sense of unity of the event participants with respect to the event.

1. A method of controlling an information processing terminal, the method comprising:
acquiring event identification information generated based on information from a first information processing terminal;
causing a monitor to display first output content, which is generated by a plurality of first input contents acquired from the first information processing terminal and is associated with the event identification information, during an event period associated with the event identification information; and
causing the monitor to display second output content generated based on second input content acquired from a second information processing terminal that has acquired event invitation information associated with the event identification information, during the event period in which an event associated with the event identification information is held, by interrupting the display of the first output content, when a first request of requesting the monitor to display at least one content is acquired from the second information processing terminal during the event period.

2. The method of controlling the information processing terminal according to claim 1, wherein
requests are rejected outside the event period.

3. The method of controlling the information processing terminal according to claim 1, wherein
when a second request of requesting the monitor to display at least one content is acquired during the event period via a website accessible during the event period from a third information processing terminal that has not received the event invitation information, but instead has acquired address information of the website displayed during the event period, the monitor displays third output content generated based on third input content acquired from the third information processing terminal via the website by interrupting the display of the first output content.

4. The method of controlling the information processing terminal according to claim 1, wherein
when the first request is acquired during the event period, the monitor displays fourth output content generated based on a plurality of the second input contents acquired from the second information processing terminal during a first period by interrupting the display of the first output content.

5. The method of controlling the information processing terminal according to claim 1, further comprising:
transmitting the event invitation information associated with the event identification information to a fourth information processing terminal; and
causing the monitor to display fifth output content generated based on the second input content acquired from the second information processing terminal and fourth input content acquired from the fourth information processing terminal by interrupting the display of the first output content when the first request is acquired and a third request of requesting the monitor to display at least one content is acquired from the fourth information processing terminal during a second period in the event period.

6. The method of controlling the information processing terminal according to claim 1, wherein
the monitor displays the first output content again after the monitor displays the second output content.

7. A display system comprising:
an information processing terminal;
a first information processing terminal connected to the information processing terminal via a network;
a second information processing terminal connected to the information processing terminal via the network; and
a monitor connected to the information processing terminal via the network, wherein the information processing terminal
acquires event identification information based on information from the first information processing terminal,
makes the monitor display first output content which is generated by a plurality of first input contents acquired from the first information processing terminal and is associated with the event identification information in an event period associated with the event identification information,
transmits event invitation information associated with the event identification information to the second information processing terminal, and
makes the monitor display second output content generated based on second input content acquired from the second information processing terminal, during the event period in which an event associated with the event identification information is held, by interrupting the display of the first output content when a first request of requesting the monitor to display at least one content is acquired from the second information processing terminal, while the first output content is displayed by the monitor during the event period.

8. The display system according to claim 7, further comprising:
a third information processing terminal which has not received the event invitation information, but instead has acquired address information of the website displayed during the event period, wherein the information processing terminal
makes the monitor display third output content generated based on third input content acquired from the third information processing terminal via a website by interrupting the display of the first output content when a second request of requesting the monitor to display at least one content is acquired during the event period via the website accessible during the event period from the third information processing terminal.

9. The display system according to claim 8, wherein
the third information processing terminal acquires a two-dimensional code which includes address information of the website and is displayed by at least one of the monitor, the first information processing terminal, and the second information processing terminal during the event period, and
the third information processing terminal transmits the second request via the website based on the address information.

10. The display system according to claim 7, wherein
when the second information processing terminal set to a first imaging mode receives an imaging operation, the second information processing terminal transmits the first request and the second input content acquired based on the imaging operation.

11. The display system according to claim 7, wherein
when the second information processing terminal set to a second imaging mode receives an imaging operation, the second information processing terminal stores the second input content in a folder,
the second information processing terminal set to the second imaging mode transmits the first request and the plurality of second input contents stored in the folder every time a third period elapses, and
fourth output content generated based on the plurality of second input contents is displayed by interrupting the display of the first output content.

12. (canceled)

13. The method of controlling the information processing terminal according to claim 1, further comprising:
after causing the display device to display the second output content by interrupting the display of the first output content, causing the display device to re-display the first output content.

14. The method of controlling the information processing terminal according to claim 1, further comprising:
preventing the monitor to display the second output content, when the first request is acquired from the second information processing apparatus outside the event period.
